(19) United States
(12) Patent Application Publication
(10) Pub. No.: US 2016/0062732 A1
(43) Pub. Date: Mar. 3, 2016

(54) METHOD FOR PROVIDING ADDITIONAL FUNCTIONS BASED ON INFORMATION

(71) Applicant: Samsung Electronics Co., Ltd., Suwon-si (KR)

(72) Inventors: Ho Jun JAYGAR, Hwaseong-si (KR); Jung Min PARK, Seoul (KR); Jin Mook LIM, Suwon-si (KR); Dae Sung HA, Suwon-si (KR); Jae Sung KU, Suwon-si (KR); Kyung Sub MIN, Seongnam-si (KR)

(21) Appl. No.: 14/838,975

(22) Filed: Aug. 28, 2015

(30) Foreign Application Priority Data
Aug. 29, 2014 (KR) 10-2014-0114102

(51) Int. Cl. G06F 7/36; G06F 17/30

(52) U.S. Cl. CPC G06F 7/36; G06F 17/30997; G06F 17/30976

(57) ABSTRACT

A method for providing information at an electronic device is provided. The method includes obtaining contents, determining one or more extraction items on the contents, extracting one or more values, corresponding to the determined one or more extraction items, from the contents, and providing reconstructed information including the extraction result.

### CROSS-REFERENCE TO RELATED APPLICATION(S)

This application claims the benefit under 35 U.S.C. §119(a) of a Korean patent application filed on Aug. 29, 2014 in the Korean Intellectual Property Office and assigned Serial number 10-2014-0114102, the entire disclosure of which is hereby incorporated by reference.

### TECHNICAL FIELD

The present disclosure relates to technology for efficiently providing information and functions/services associated with the information in an electronic device such as a smart phone, a tablet, a music player, a smart watch, or an infotainment system of a vehicle.

### BACKGROUND

An electronic device may provide a user with a variety of information. For example, an electronic device such as a smart phone may provide a variety of information, such as a variety of reservation and guide information, through a short message service (SMS), e-mail, or a screen (a user interface (UI)) of a related application. Furthermore, a user may connect to a specific website or a bulletin board service using an electronic device and may obtain various contents.

When checking necessary information, a user of an electronic device may be frequently provided with the considerable amount of unnecessary information. For example, plane ticket reservation information received through the SMS may include currently unneeded information (e.g., various provisions such as a refund provision or restrict items, guide, alarm items, and the like) as well as essential information (e.g., information on departure/arrival time, flight name, and the like).

Furthermore, the user of the electronic device may reserve a room at a hotel through a website in a language of any other country. In this case, the user may receive the e-mail containing hotel reservation information but may have trouble to search for necessary information from the e-mail in a foreign language.

The electronic device may also receive various types of multimedia data including a text and an image through a multimedia message service (MMS) or the e-mail. As types of multimedia data become diverse, the user may have trouble checking information, determined as being necessary or important, among various and numerous amounts of data. Furthermore, in the case where an image is received or information is received in the format of a document including an image, a characteristic of the image may make it difficult to select a necessary item.

Meanwhile, connection between text information and an application in a smart phone of the related art may depend on the expression format of text. For example, a text having a format such as time and minute or month and date may be underlined, and if a corresponding text is selected, a schedule application (e.g., a calendar application) may be executed. This method, however, may not provide any other additional information than the time or date information to the schedule application, and such connection (underline) may be provided even to a text not associated with a schedule.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a technique for extracting necessary information by analyzing various formats of contents to be provided to a user through an electronic device, thereby making it possible to provide the extracted information or execute an application associated with the extracted information.

Another aspect of the present disclosure is to provide a technique for collecting log information associated with analysis success or analysis failure and consistently updating a template needed for analysis using the collected log information, thereby improving the accuracy of the extracted information.

In accordance with an aspect of the present disclosure, a method for providing information at an electronic device is provided. The method includes obtaining contents, determining one or more extraction items on the contents, extracting one or more values, corresponding to the determined one or more extraction items, from the contents, and providing reconstructed information including the extraction result.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates an exemplification of a system for providing text-based contents information according to various embodiments of the present disclosure;

FIG. 2 illustrates a method in which a user terminal extracts information using a template according to various embodiments of the present disclosure;

FIG. 3 illustrates an exemplification in which information is obtained and reconstructed from contents and obtained information is provided to any other application linked according to various embodiments of the present disclosure;

FIG. 4 illustrates a configuration of an electronic device and a server according to various embodiments of the present disclosure;

FIG. 5 illustrates a process for extracting and providing text-based contents according to various embodiments of the present disclosure;

FIG. 6 illustrates a template deciding process according to various embodiments of the present disclosure;

FIG. 7 illustrates an exemplification of a template structure according to various embodiments of the present disclosure;

FIG. 8 illustrates an exemplification in which an entity value is extracted using node information and regular expression according to various embodiments of the present disclosure;

FIG. 9 illustrates an entity extracting process according to various embodiments of the present disclosure;

FIG. 10 illustrates a log processing process associated with extraction failure according to various embodiments of the present disclosure;

FIG. 11 illustrates an exemplification in which reconstructed information is provided in the format of toast message according to various embodiments of the present disclosure;

FIG. 12 illustrates an exemplification in which text-based contents are replaced with reconstructed information according to various embodiments of the present disclosure;

FIG. 13 illustrates an exemplification in which reconstructed information is provided at a notification bar area according to various embodiments of the present disclosure;

FIG. 14 illustrates an exemplification in which flight reservation information is provided according to various embodiments of the present disclosure;

FIG. 15 is a diagram illustrating an electronic device in a network environment according to various embodiments of the present disclosure;

FIG. 16 is a block diagram illustrating an electronic device according to various embodiments of the present disclosure; and

FIG. 17 is a block diagram illustrating a program module according to various embodiments of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications, of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the disclosure disclosed herein, the expressions “have”, “may have”, “include” and “comprise”, or “may include” and “may comprise” used herein indicate existence of corresponding features (e.g., elements such as numeric values, functions, operations, or components) but do not exclude presence of additional features.

In the disclosure disclosed herein, the expressions “A or B”, “at least one of A or/and B”, or “one or more of A or/and B”, and the like used herein may include any and all combinations of one or more of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included.

The terms, such as “first”, “second”, and the like used herein may refer to various elements of various embodiments of the present disclosure, but do not limit the elements. For example, such terms do not limit the order and/or priority of the elements. Furthermore, such terms may be used to distinguish one element from another element. For example, “a first user device” and “a second user device” indicate different user devices. For example, without departing the scope of the present disclosure, a first element may be referred to as a second element, and similarly, a second element may be referred to as a first element.

It will be understood that when an element (e.g., a first element) is referred to as being “(operatively or communicatively) coupled with/to” or “connected to” another element (e.g., a second element), it can be directly coupled with/to or connected to the other element or an intervening element (e.g., a third element) may be present. In contrast, when an element (e.g., a first element) is referred to as being “directly coupled with/to” or “directly connected to” another element (e.g., a second element), it should be understood that there are no intervening element (e.g., a third element).

According to the situation, the expression “configured to” used herein may be used as, for example, the expression “suitable for”, “having the capacity to”, “designed to”, “adapted to”, “made to”, or “capable of”. The term “configured to” must not mean only “specifically designed to” in hardware. Instead, the expression “a device configured to” may mean that the device is “capable of” operating together with another device or other components. For example, a “processor configured to perform A, B, and C” may mean a dedicated processor (e.g., an embedded processor) for performing a corresponding operation or a generic-purpose processor (e.g., a central processing unit (CPU) or an application processor (AP)) which may perform corresponding operations by executing one or more software programs which are stored in a memory device.

Unless otherwise defined herein, all the terms used herein, which include technical or scientific terms, may have the same meaning that is generally understood by a person skilled in the art. It will be further understood that terms, which are defined in a dictionary and commonly used, should also be interpreted as is customary in the relevant related art and not in an idealized or overly formal detect unless expressly so defined herein in various embodiments of the present disclosure. In some cases, even if terms are terms which are defined in the specification, they may not be interpreted to exclude various embodiments of the present disclosure.

An electronic device according to various embodiments of the present disclosure may include at least one of smartphones, tablet personal computers (PCs), mobile phones, video telephones, electronic book readers, desktop PCs, laptop PCs, netbook computers, workstations, servers, personal digital assistants (PDAs), portable multimedia players (PMPs), moving picture experts group (MPEG-1 or MPEG-2) audio layer 3 (MP3) players, mobile medical devices, cameras, wearable devices (e.g., head-mounted-devices (HMDs), such as electronic glasses), an electronic apparel, electronic bracelets, electronic necklaces, electronic accessories, electronic tattoos, smart watches, and the like.

According to various embodiments of the present disclosure, the electronic devices may be smart home appliances. The smart home appliances may include at least one of, for example, televisions (TVs), digital versatile disc (DVD) players, audios, refrigerators, air conditioners, cleaners, ovens, microwave ovens, washing machines, air cleaners, set-top boxes, TV boxes (e.g., Samsung HomeSync™, Apple TV™, or Google TV™), game consoles (e.g., Xbox™ and PlayStation™), electronic dictionaries, electronic keys, camcorders, electronic picture frames, and the like.

According to various embodiments of the present disclosure, the electronic devices may include at least one of medical devices (e.g., various portable medical measurement devices (e.g., a blood glucose monitoring device, a heartbeat measuring device, a blood pressure measuring device, a body temperature measuring device, and the like)), a magnetic resonance angiography (MRA), a magnetic resonance imaging (MRI), a computed tomography (CT), scanners, and ultrasonic devices) receiving a user input in an idle mode, navigation devices, global positioning system (GPS) receivers, event data recorders (EDRs), flight data recorders (FDRs), vehicle infotainment devices, electronic equipment for vessels (e.g., navigation systems and gyrocompasses), avionics, security devices, head units for vehicles, industrial or home robots, automatic teller machines (ATMs), points of sales (POSs), or internet of things (e.g., light bulbs, various sensors, electric or gas meters, sprinkler devices, fire alarms, thermostats, street lamps, toasters, exercise equipment, hot water tanks, heaters, boilers, and the like).

According to various embodiments of the present disclosure, the electronic devices may include at least one of parts of furniture or buildings/structures, electronic boards, electronic signature receiving devices, projectors, or various measuring instruments (e.g., water meters, electricity meters, gas meters, or wave meters, and the like). The electronic devices according to various embodiments of the present disclosure may be one or more combinations of the above-mentioned devices. According to various embodiments of the present disclosure, an electronic device may be a flexible electronic device. Also, electronic devices according to various embodiments of the present disclosure are not limited to the above-mentioned devices, and may include new electronic devices according to technology development

Hereinafter, electronic devices according to various embodiments of the present disclosure will be described with reference to the accompanying drawings. The term “user” used herein may refer to a person who uses an electronic device or may refer to a device (e.g., an artificial electronic device) that uses an electronic device.

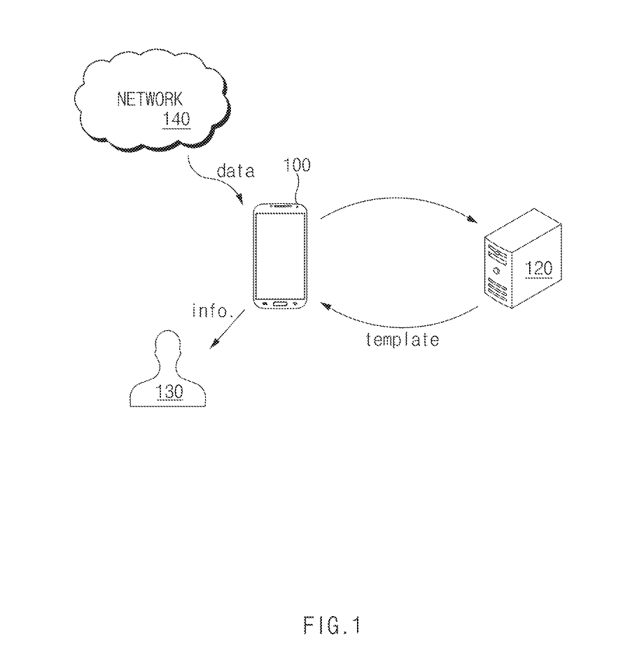

FIG. 1 illustrates an exemplification of a system for providing information of contents according to various embodiments of the present disclosure.

Referring to FIG. 1, a user terminal (or user equipment (UE)) may be provided with data from a network 140. The data may be text-based contents. According to various embodiments of the present disclosure, the “text-based contents” may include all text-based contents generated at an electronic device, such as web contents, short message service (SMS), e-mail, chatting, and the like. For example, SMS, e-mail, contents of a website, and the like that a terminal 100 receives through a wired or wireless internet, a cellular network, or the like may correspond to the above-described text-based contents.

Various embodiments of the present disclosure may not be limited to the case that the text-based contents only include text data. The text-based contents may include various formats of data, such as an image and a video, as well as a text. The text-based contents may be expressed using a structured document such as hypertext markup language (html), hypertext preprocessor (php), or extensible markup language (xml). For example, the text-based contents of the present disclosure may include a webpage including an image and a video and contents of an internet website as well as the SMS only including characters.

However, various embodiments of the present disclosure may be applied to contents that are based on various formats or structures. Contents must not be limited to the text-based contents, and contents which a method or a technical feature to be described later is applied to may be understood as being contents to be mentioned in various embodiments. In this specification, a description will be exemplarily given according to the text-based contents without limiting the scope or spirit of the present disclosure.

According to various embodiments of the present disclosure, the user terminal 100 may correspond, in general, to an electronic device such as a smart phone (e.g., Samsung Galaxy S5) or a tablet (e.g., Galaxy Note 10.1). Besides the exemplification, the user terminal 100 may include a wearable device such as a smart watch (e.g., Galaxy Gear 2), a desktop PC, or an electronic device such as a laptop. In general, devices which obtain the text-based contents, extract and construct information from the obtained contents, and provide it through displays thereof or a combination thereof may correspond to the user terminal 100 according to various embodiments of the present disclosure.

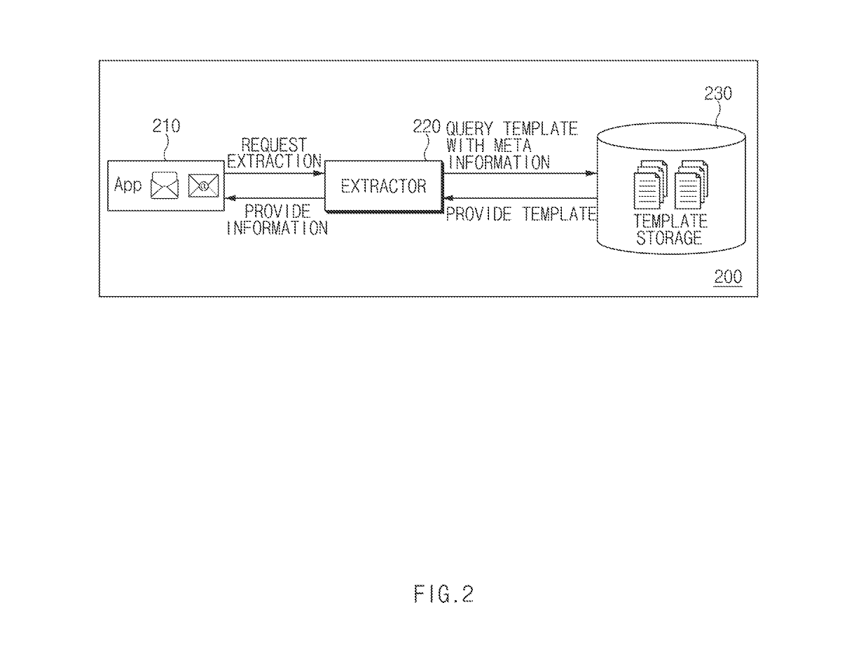

The user terminal 100 may analyze contents and may provide a user 130 with information obtained according to an analysis result. According to various embodiments of the present disclosure, the user terminal 100 may use a template to analyze contents. Contents may have a structured format. For example, entities “a”, “b”, “c”, and “d” of a text structure A may exist at specific positions in the text structure A. For example, a template A1 for the text structure A may have information on positions in the text structure A where the entities “a”, “b”, “c”, and “d” are placed. Accordingly, it may be possible to extract values corresponding to the entities “a”, “b”, “c”, and “d” by applying the template A to the text structure A. A method for extracting entities using a template will be described in detail with reference to FIGS. 2, 5, and 9.

In this specification, the “entity” may be understood as being a unit of meaning organizing information. For example, in the text-based contents, date, time, position, site, flight name, price, movie title, product name, production year, mileage, manufacturer, brand, and the like may correspond to entities. Entities may be defined in a template. The user terminal 100 may extract and classify (group) values corresponding to entities defined in a template and may provide the user 130 with specific information such as reservation information and purchasing information. According to various embodiments of the present disclosure, an electronic device (e.g., a user terminal 100) may extract an item corresponding to an entity. According to various embodiments of the present disclosure, an entity or an entity item may be understood as being an extraction item.

The user terminal 100 may record a result of extracting information (entity) using a template and may provide a server 120 with a log thereof. According to various embodiments of the present disclosure, the log may be reported to the server 120 even at a situation such as extraction success as well as extraction failure. A log provided to the server 120 may be used to generate, revise, and update a template.

The user terminal 100 may be provided with a new template or an updated template from the server 120. As a template is provided consistently or automatically, the probability that the user terminal 100 fails to extract information through the template may be reduced, and reliability on extracted information may be assured.

FIG. 2 illustrates a method in which a user terminal extracts information using a template according to various embodiments of the present disclosure. A user terminal 200 of FIG. 2 may be, for example, a user terminal 100 of FIG. 1.

Referring to FIG. 2, an application 210 may provide an extractor 220 with contents included in a received message or e-mail. Furthermore, the application 210 may request the extractor 220 to extract information on the contents. According to various embodiments of the present disclosure, the extractor 220 may be implemented with a separate hardware module, or a function of the extractor 220 may be performed by a processor (e.g., an AP) or a CPU.

According to various embodiments of the present disclosure the extractor 220 may request (e.g., query) a template needed to analyze the contents at a template storage unit 230. The extractor 220 may request an appropriate template at the template storage unit 230 using metadata. For example, to select a template on an SMS received by a specific number (e.g., 1588-0505), the extractor 220 may select one or more templates, corresponding to the metadata, from among templates stored at the template storage unit 230 using information that a type of application is SMS” and information that an outgoing call number is “1588-0505” as metadata. For example, if there is received e-mail of which the sender e-mail address is “customer@koreanair.co.kr”, the extractor 220 may select an appropriate template stored at the template storage unit 230 using information that a type of application is “e-mail” and information that a sender e-mail address is “customer@koreanair.co.kr” as metadata. For example, in the case where contents in a website “http://samsungtomorrow.com/” are being output, the extractor 220 may obtain a template from the template storage unit 220 using information that a type of application is “browser” (e.g., Chrome, Safari, Opera, Firefox, Internet Explorer, or the like) and information that a website address is “http://samsungtomorrow.com/” as metadata.

As other embodiments, the user terminal 200 may use information on an application, providing text-based contents, and source information of the provided contents as metadata. According to various embodiments of the present disclosure, however, metadata may be sufficient as including information for deciding a template from the template storage unit 230, and may not be limited thereto. For example, in FIG. 1, location information of a user 130, area information of a user terminal 100 (e.g., a European type terminal, a American type terminal, a global model, or the like), a preferable language or set language of the user terminal 100, and the like may be used as metadata.

According to an embodiment the extractor 220 may provide an application 210 with information obtained from contents using a template. The information may be provided in a variety of formats. For example, contents originally provided by a first format on an application may be replaced with reconstructed information of a second format. As another example, reconstructed information of a third format may be output in a manner where it may be overlaid or popped up on contents output by the first format. According to various embodiments of the present disclosure, information which is extracted from text-based contents obtained by the application 210 may be provided to an application different from the application 210 or to a toggle screen such as noti-bar.

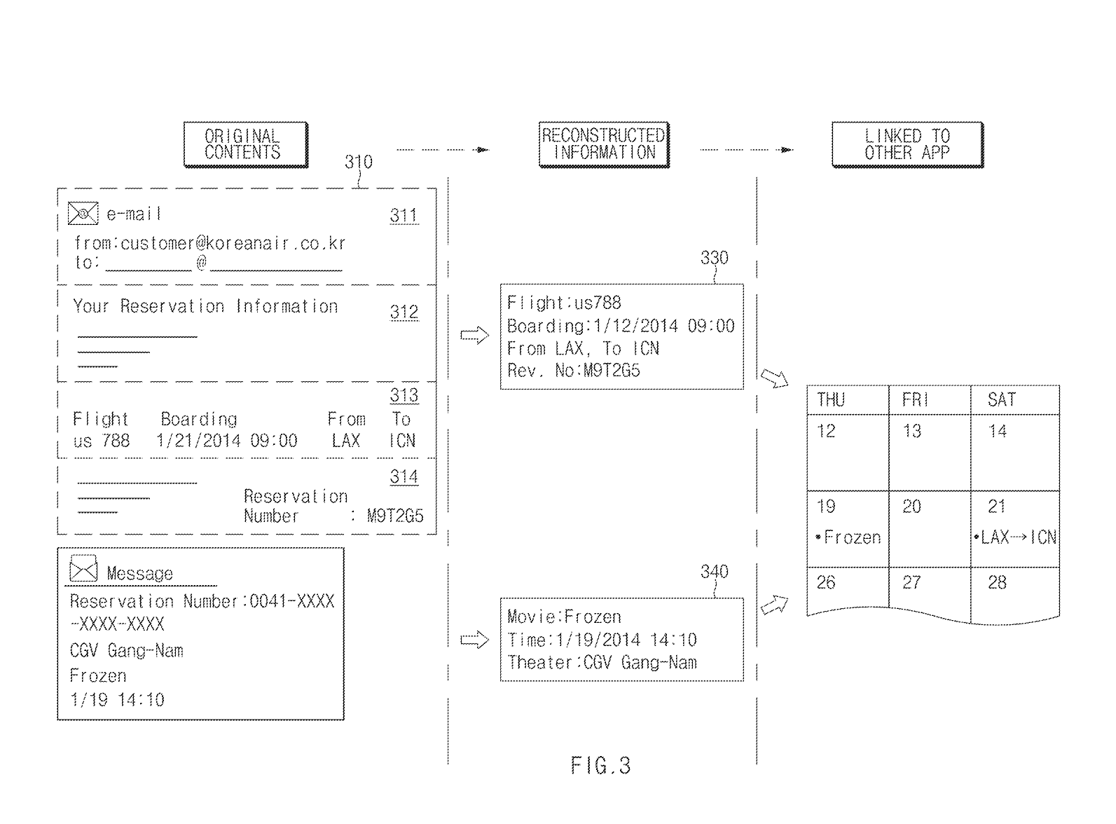

FIG. 3 illustrates an exemplification in which information is obtained and reconstructed from contents and obtained information is provided to another application linked according to various embodiments of the present disclosure.

According to an embodiment an image illustrated at the right of FIG. 3 may illustrate an exemplification of original contents. For example, a user terminal (e.g., a user terminal 200) may receive e-mail 310 from “customer@koreanair.co.kr”. The e-mail 310 may be text-based contents. According to various embodiments of the present disclosure, the e-mail 310 may correspond to a structured document (e.g., a document having a structure of html, xml, or the like) including a text and an image. Furthermore, according to various embodiments of the present disclosure, the e-mail 310 may be image-based contents (e.g., e-mail of which the contents are mostly formed of an image). In the case where the e-mail 310 is image-based contents, conversion into text-based contents may be made using a text which is obtained by pre-processing information through a character recognition function on an image (e.g., optical character recognition (OCR)). If the e-mail 310 is voice or video-based e-mail, conversion into text-based contents may be made using a text which is obtained by pre-processing information (e.g., a voice recognition function or the like). According to various embodiments of the present disclosure, formats of original contents may be various, not limited to one format.

The e-mail 310 may include a block 311 including information on a receiver/sender account, a block 312 in which a general guide message is recorded, a block 313 in which reservation information is recorded, and a block 314 in which any other information and a reservation number are recorded. The format of the e-mail 310 of FIG. 3 may be exemplary. For example, the e-mail 310 may be text-based contents having the format of table or may be constructed in a way such that reservation information is recorded in various blocks.

If receiving the e-mail 310, the user terminal 100 may obtain the e-mail as text-based contents from an e-mail application. The user terminal 100, as described above, may select an appropriate template to extract information included in the e-mail 310. At this time, the user terminal 100 may select a template corresponding to metadata using a type of application (e-mail) and sender information (customer@koreanair.co.kr) as the metadata.

The selected template may include a plurality of extraction items (e.g., entities). For example, a template selected by the metadata may include information on a plurality of extraction items to be extracted from a document structure of a reservation guide e-mail sent from the Korean Air. For example, a template selected with respect to the e-mail 310 may include extraction items such as flight, boarding, from, to and reservation number. The user terminal 100 may extract values (entity values) corresponding to the extraction items from the e-mail 310 using the template.

The user terminal 100 may generate reconstructed information (e.g., flight information 330) using the extraction item (e.g., flight) and the extracted entity value (e.g., US 788). For example, the user terminal 100 may extract information corresponding to flight name, departure time, arrival time, destination, and reservation number to provide the flight information 330.

According to various embodiments of the present disclosure, the reconstructed flight information 330 may be linked to an application (e.g., a calendar application) different from an application (e.g., an e-mail application) providing contents. For example, the user terminal 100 may provide the reconstructed information 330 together with an option querying whether to add contents included in information to the different application. For example, the reconstructed information 330 may be added to a schedule (e.g., flight in Jan. 21, 2014) of the different application (e.g., a calendar application 350).

According to various embodiments of the present disclosure, original contents may be provided through the SMS or an interactive application such as Chat On. For example, the user terminal 100 may receive an SMS message 320 including reservation information of a movie.

The user terminal 100 may select an appropriate template to extract reservation information from text-based contents of the SMS message 320. For example, the SMS message 320 may include information on a reservation number, a theater, a movie title, and a show time. A template may be used to extract information on a movie title, a show time, and a theater from the SMS message 320. Reservation information 340 may be generated by reconstructing the extracted information. It may be understood that the exemplarily described template is used to further extract additional information such as a reservation number and the like.

Like the above-described flight information 330, the reservation information 340 may be provided in connection with any other application. For example, a schedule on a movie “Frozen” to be screened in Jan. 19, 2014 may be added to the calendar application 350.

An embodiment of the present disclosure is exemplified in FIG. 3 as pieces of reconstructed information are registered at the calendar application 350, but reconstructed information may be linked to various applications. For example, in the case where a sender address of an SMS message is a business registration number of the CGV Theater, a template which is selected using the number information as metadata may allow reconstructed information to be linked to a CGV theater application. Besides, a template may allow reconstructed information to be linked to a website, which will be described in detail later.

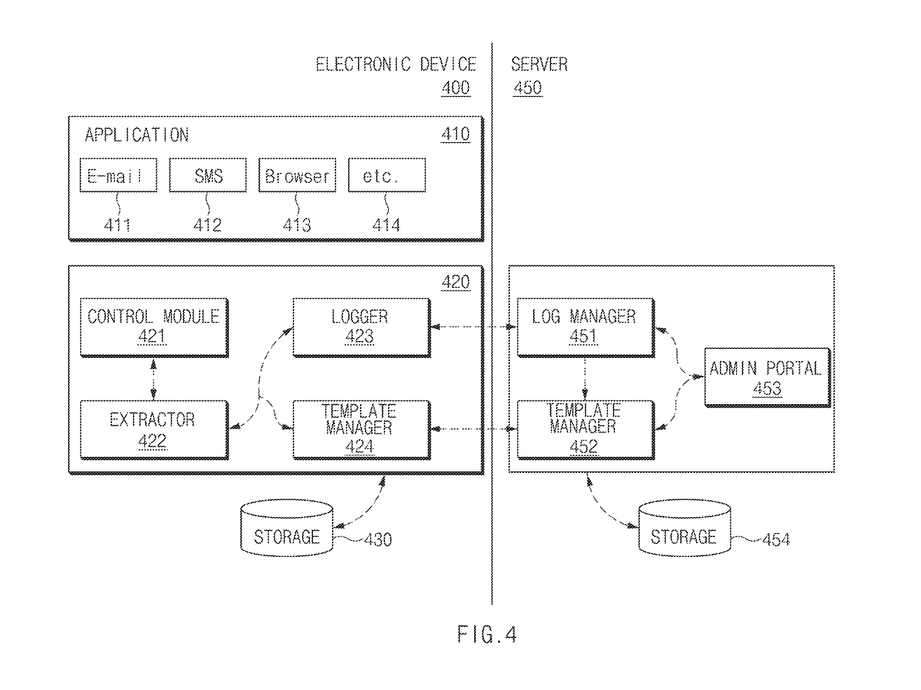

FIG. 4 illustrates a configuration of an electronic device and a server according to various embodiments of the present disclosure. An electronic device 400 and a server 450 illustrated in FIG. 4 may be understood as being a user terminal 100 and a server 120 illustrated in FIG. 1, respectively.

Referring to FIG. 4, an electronic device 400 may process data obtained in an application 410 on a framework (e.g., an information extraction framework) 420. The electronic device 400 may use a variety of data (e.g., templates, log information, and the like), stored at a storage unit 430, to process data. In other words, each module of the electronic device 400 may process data provided by the application 410 on the framework 420 and may provide a processed result to an original application, to any other application, or to a server 450.

The electronic device 400 may include an e-mail application 411, an SMS application 412, a browser application 413, and any other applications 414. According to an embodiment of the present disclosure, the application 410 may obtain (or receive) various formats of information as text-based contents and may provide it to the framework 420.

Various modules of the electronic device 400 may operate on the framework 420. For example, a control module 421, an extractor 422, a logger 423, and a template manager 424 may operate on the framework 420. An embodiment of the inventive concept is exemplified in FIG. 4 as various modules are separate hardware components, but a plurality of modules may be mutually integrated to perform a function. For example, the control module 421 and the extractor 422 may be implemented in the form of AP or system on chip (Soc).

A hardware configuration of the electronic device 400 may not be limited to an exemplification illustrated in FIG. 4. For example, the electronic device 400 may further include an application launcher (not illustrated) for executing an application linked to information extracted by the extractor 422. Furthermore, the electronic device 400 may further include a communication module (not illustrated) which transfers a log recorded by the logger 423 to the server 450 or receives a template from the server 450.

According to various embodiments of the present disclosure, the control module 421 may execute an application 410. According to various embodiments of the present disclosure, the control module 421 may be an AP. Furthermore, the control module 421 may perform or control an overall function for driving the electronic device 400. The control module 421 may also provide the extractor 422 with various contents (e.g., an e-mail, a message, a web page, and the like received through a communication module) obtained by the application 410 as an input. According to some embodiments of the present disclosure, the control module 421 may provide the template manager 424 with text-based contents provided by the application 410 without delay.

The extractor 422 may provide text-based contents to the template manager 424. The extractor 422 may also extract entity information from contents using a template selected by the template manager 424. Furthermore, the extractor 422 may provide an extraction result (success/fail) to the logger 423. The extractor 422 may be understood as being an exemplification of an extractor 220 of FIG. 2.

The logger 423 may record a result of extracting information using a template and may provide it to the server 450. The logger 423 may store the extraction result at the storage unit 430.

The template manager 424 may select, from the storage unit 430, a template for extracting information included in text-based contents. In this case, the storage unit 430 may be understood as being a template storage unit 230 of FIG. 2.

Meanwhile, the template manager 424 may provide the selected template to the extractor 422. The template manager 424 may also request a new template or a needed template at the server 450 or may receive an updated template from the server 450.

According to various embodiments of the present disclosure, the electronic device 400 may include the storage unit 430. The storage unit 430 may be an embedded memory or may be an external memory removable from the electronic device 400.

According to an embodiment of the present disclosure, the electronic device 400 may not include the storage unit 430. For example, the template manager 424 may transfer information (e.g., metadata and the like) needed to select a template to the server 450, and the template manager 452 of the server 450 may select an appropriate template from the storage unit 454 to provide it to the template manager 424. Here, that the electronic device 400 does not include the storage unit 430 may mean that templates are not previously stored at a memory device which the electronic device 400 includes, not that the electronic device 400 does not include a memory device.

The storage unit 430 may include template database (DB) and log DB. The template DB and the log DB may be understood as being a template storage unit (e.g., a template storage unit 230) and a log storage unit physically divided. According to an embodiment of the present disclosure, however, the template and log DBs may be constructed with logically divided areas of a memory device. According to various embodiments of the present disclosure, the template manager 424 may select a template from the template DB, and the logger 423 may store a log on an extraction result at the log DB.

The server 450 may include a log manager 451, a template manager 452, an admin portal 453, and a storage unit 454. The log manager 451 may collect a log on an extraction result from the logger 423 of the electronic device 400 to provide it to the template manager 452 or the admin portal 453. The template manager 452 may select an appropriate template from the storage unit 454 based on the obtained log or a request of the template manager 424 of the electronic device 400 and may provide the selected template to the electronic device 400 or corresponding information to the admin portal 453. The admin portal 453 may analyze the obtained log or may generate/revise/delete/update a template.

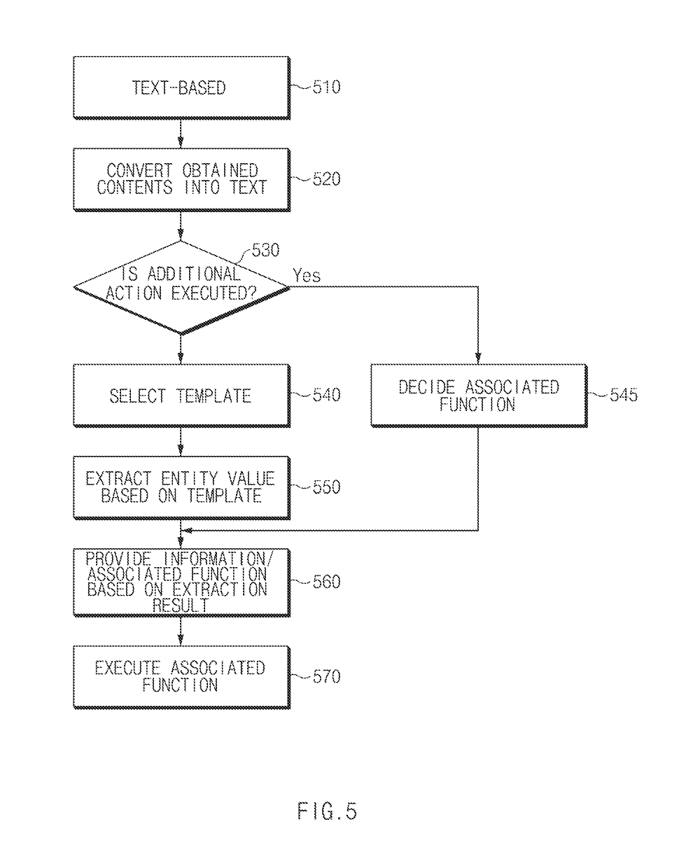

FIG. 5 illustrates a process for extracting and providing text-based contents according to various embodiments of the present disclosure.

Referring to FIG. 5, in operation 510, an electronic device 400 may obtain contents. For example, the electronic device 400 may receive a message, e-mail, web contents, and the like through a wired/wireless internet such as wireless fidelity (Wi-Fi) or local area network (LAN), a cellular network such as 3rd-generation (3G), 4^{th} generation (4G), long term evolution (LTE), LTE-advanced (LTE-A), and the like, or a local area network such as Bluetooth (BT) or near field communication (NFC). Each application 410 may provide obtained contents to the framework 420. According to various embodiments of the present disclosure, the application 410 of the electronic device 400 may internally generate contents without communicating with an external network, and the contents internally generated may be also provided to the framework 420.

In operation 520, the electronic device 400 may perform a task for converting obtained contents into text-based contents. For example, in the case where a portion of e-mail that a user receives is constructed with an image, an image of a corresponding area (field) may be replaced with a text. For example, the electronic device 400 may further include an OCR engine, and may replace a value of a corresponding area (field) with a text by applying OCR to an area of the obtained contents which is not constructed with a text. After performing operation 500, the electronic device 400 may perform operation 510.

According to various embodiments of the present disclosure, in the case where the obtained contents are an image or image-based contents, the electronic device 400 may obtain a text by performing operation 50 with respect to the whole of the image. Furthermore, according to various embodiments of the present disclosure, the electronic device 400 may convert the obtained contents into the format of text-based contents by applying a text extraction method to a voice message or an audio/video input.

According to various embodiments of the present disclosure, in operation 510, the electronic device 400 may obtain text-based contents. In this case, operation 520 may be skipped because the obtained contents are text-based contents.

In operation 530, the electronic device 400 may determine whether to provide an additional action (e.g., schedule registration, website connection, and the like) with respect to the obtained contents. If an additional action is performed with respect to the obtained contents, in operation 545, the electronic device 400 may select a function associated with the action. For example, a calendar application execution function may be selected in case of schedule registration, and a browser application execution function may be selected in case of website connection. According to various embodiments of the present disclosure, an associated function may be selected according to a type of obtained contents or a type of application providing contents, but may be defined at a template. For example, if a template is selected in operation 540, a corresponding template may include a list of functions to be provided together with an extraction result. Below, a template selection process will be described.

In operation 540, the electronic device 400 may select a template to be applied to contents. According to various embodiments of the present disclosure, a template manager 424 may select at least one among plural templates stored at a storage unit 430, using metadata provided from an extractor 422. According to some embodiments of the present disclosure, the template manager 424 may provide the metadata to a server 450 or may be provided with a template from the server 450.

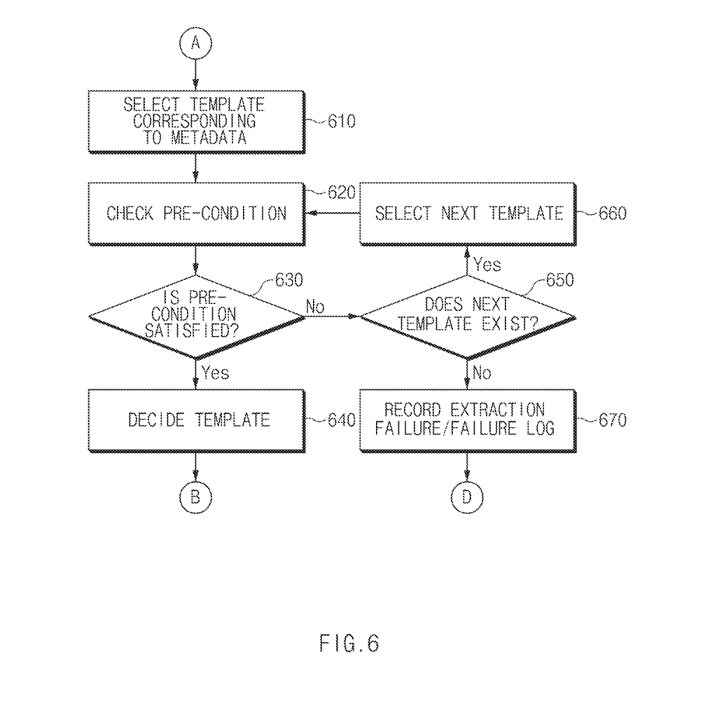

According to various embodiments of the present disclosure, the template manager 424 may decide a template to be applied to text-based contents using a pre-condition item. This will be described in detail with reference to FIG. 6.

In operation 550, the electronic device 400 may extract an entity value included in a template, based on a template selected in operation 520. The template may include information on an entity item corresponding to an extraction target of text-based contents. Furthermore, an entity may be classified into an essential entity or a general entity. Here, the essential entity may be an entity necessitating extraction of an entity value, and the general entity may be an entity which does not cause a serious problem to organize information even though a corresponding entity value is not extracted.

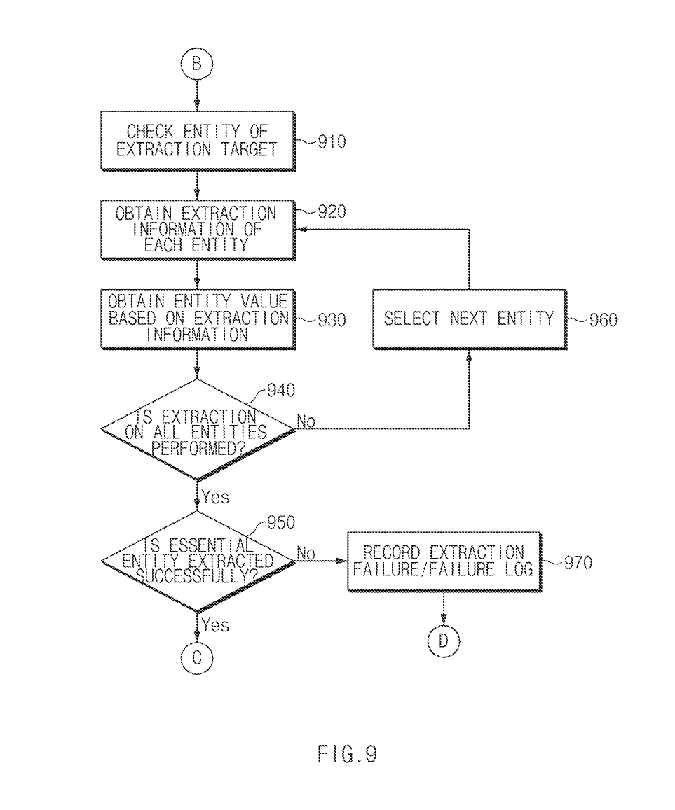

In an embodiment of FIG. 3, for example, a template to be applied to a message 320 may define a movie title, a show time, and a theater as essential entities and a reservation number may be defined as a general entity. In this case, if essential entities all are extracted even though a reservation number is not extracted, a user terminal 100 may provide appropriately reconstructed reservation information 340. In the case of failing to extract all essential entities defined at a template from text-based contents, an extraction failure log may be recorded. This will be described in detail with reference to FIG. 9.

In operation 560, the electronic device 400 may provide information and/or an associated function or service based on an extraction result of operation 530. For example, the extractor 422 may extract an entity value from contents using a template, and a control module 421 may reconstruct information using an entity item and the extracted entity value and may provide the reconstructed information to a user through an output device (e.g., a display) of the electronic device 400. In this case, the electronic device 400 may also provide an associated function selected in operation 545, for example, an application linked to the reconstructed information or an item associated with a website. Furthermore, in operation 570 the electronic device 400 may execute an associated function included in a template selected in operation 540.

FIG. 6 illustrates a template deciding process according to various embodiments of the present disclosure.

FIG. 6 may be understood as being one of various embodiments of a detailed process of operation 520. For example, operation A of FIG. 6 may be understood as being operation 510 of FIG. 5. According to various embodiments of the present disclosure, operation A may be any process which is able to be executed between operation 510 and operation 610. For example, operation A may be performed to decide metadata of text-based contents. A description given in FIG. 5 may become a pre-condition of a description of FIG. 6 or may be applied to describe FIG. 6.

In operation 610, a template manager 424 may select a template corresponding to metadata. According to various embodiments of the present disclosure, a template may include information on a unique template key, and the template manager 424 may perform matching between metadata and a template key. The template manager 424 may select a matched template. In e-mail received from the Korean Air, for example, there may be selected a template having a template key corresponding to metadata including information that a type of application is “e-mail” and information that a sender address is “customer@koreanair.co.kr”. Accordingly, it may be possible to select one template or a plurality of templates.

In operation 620, the template manager 424 may check the template selected in operation 610. In operation 630 it is determined whether the pre-condition is satisfied. The pre-condition may be understood as being an item for primarily determining whether a template is suitable to be applied to contents (or whether contents are suitable to apply a template thereto).

For example, an electronic device 400 may extract and reconstruct information from a billing guide message, which is received from a communication provider, using an appropriate template. However, the communication provider may send various messages, such as service application/end, event, and the like, as well as fare information. For this reason, in the light of resource management, it may be inappropriate to extract all entities of a template, selected by metadata, whenever a message is received. Accordingly, the electronic device 400 may primarily check a pre-condition with respect to the received message, for example, whether expression such as “billing” or “payment” exists, whether expression of a currency form such as 53,000 won” or “7.800$” exists, and the like.

As another exemplification, the electronic device 400 may receive e-mail associated with reservation information on accommodations, tourist spots or plane tickets from an airline. Furthermore, the electronic device 400 may receive e-mail associated with payment information, cancellation information, refund information, use guide information, and the like from the same airline e-mail account. In the above exemplification, a plurality of templates for extracting information included in e-mail from an airline, such as a template for extracting reservation information, a template for extracting payment information, and the like may be selected by metadata (an e-mail application and an airline e-mail account). The electronic device 400 may check a pre-condition to determine whether it is appropriate to apply the selected templates to obtained text-based contents.

Continuing to refer to FIG. 6, if a pre-condition of a selected template is determined as being satisfied by text-based contents, in operation 640, the template manager 424 may select a corresponding template as a template for entity extraction.

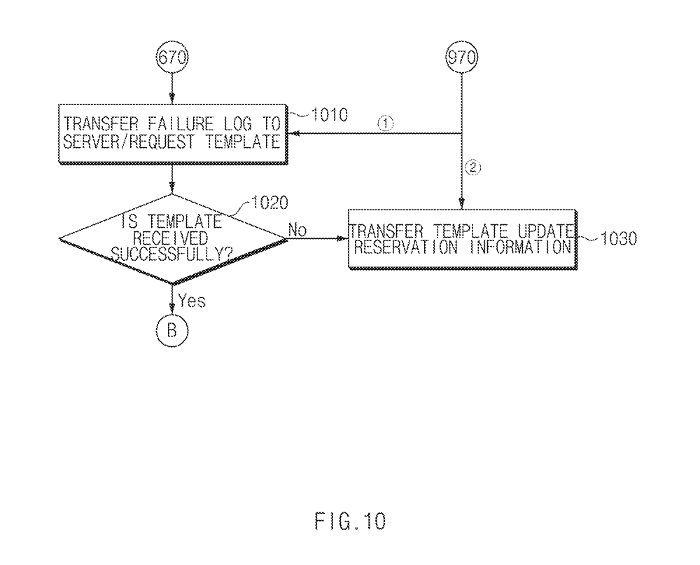

If a pre-condition of a selected template is determined as not being satisfied by text-based contents, in operation 650, the template manager 424 may decide whether a next template selected in operation 610 exists. For example, in the case where five templates corresponding to metadata are selected in operation 610 and a template not experiencing pre-condition check in operation 650 exists, in operation 660, the template manager 424 may select the template not experiencing pre-condition check and may perform operation 620. If a pre-condition is checked with respect to five templates, in operation 670, the template manager 424 may record a log indicating failure in information extraction. Log processing after extraction failure will be described in detail with reference to FIG. 10.

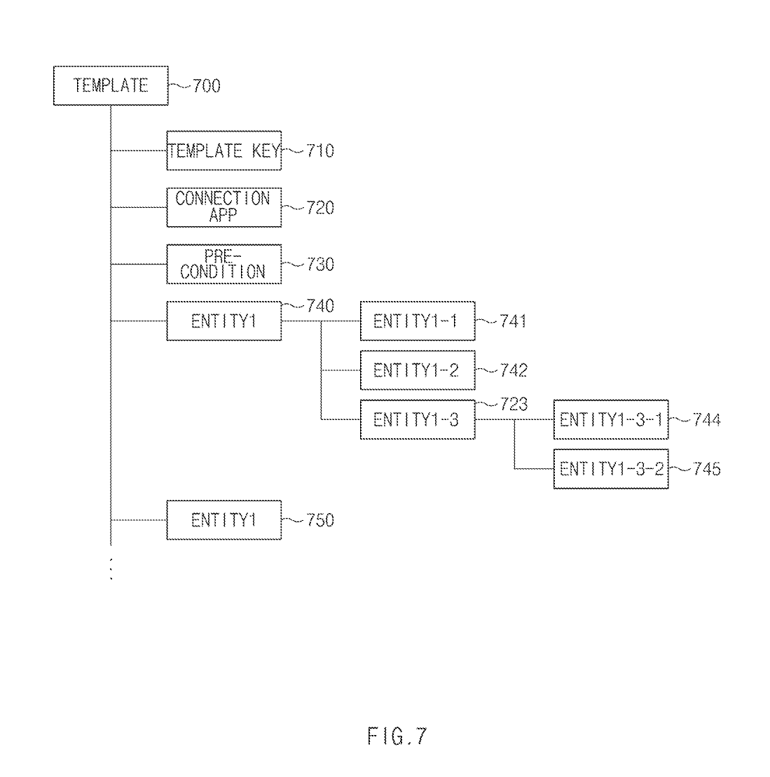

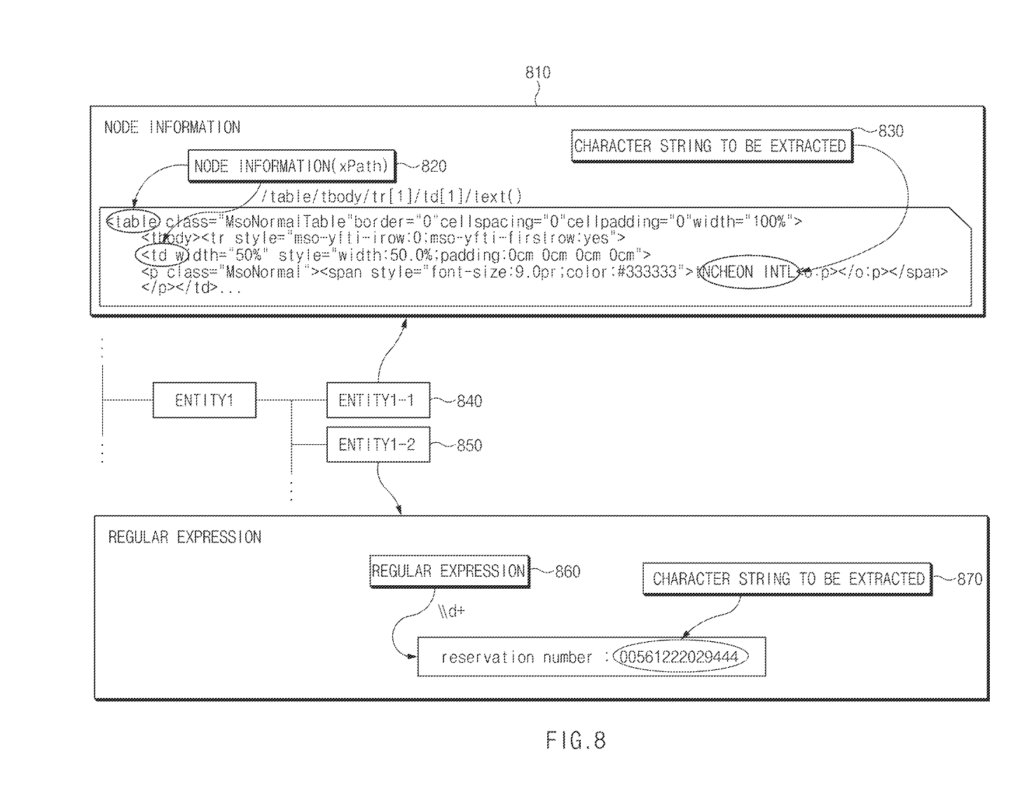

If a template is selected in operation 640, the process may proceed to operation B. According to various embodiments of the present disclosure, operation B may correspond to extracting an entity value based on a selected template (e.g., operation 530 of FIG. 5). According to various embodiments of the present disclosure, an extractor 422 may use information on a node of each entity included in a template and/or regular expression information. Below, a template structure will be described with reference to FIG. 7, node information and regular expression will be described with reference to FIG. 8, and an entity extraction process will be described with reference to FIG. 9.

FIG. 7 illustrates an exemplification of a template structure according to various embodiments of the present disclosure.

Referring to FIG. 7, a template 700 may include a template key 710, a connection app 720, a pre-condition item 730, and a plurality of entities (e.g., entities 740 and 750). Here, the template key 710 may be information (e.g., unique character string key value such as an e-mail address, a telephone number, and uniform resource locator (URL) for primarily selecting a template through matching with the above-described metadata. Furthermore, the pre-condition 730 may be a condition for determining whether a primarily selected template is suitable for contents, by checking contents of an input text (text-based contents) when it is impossible to select a template only using the template key 710.

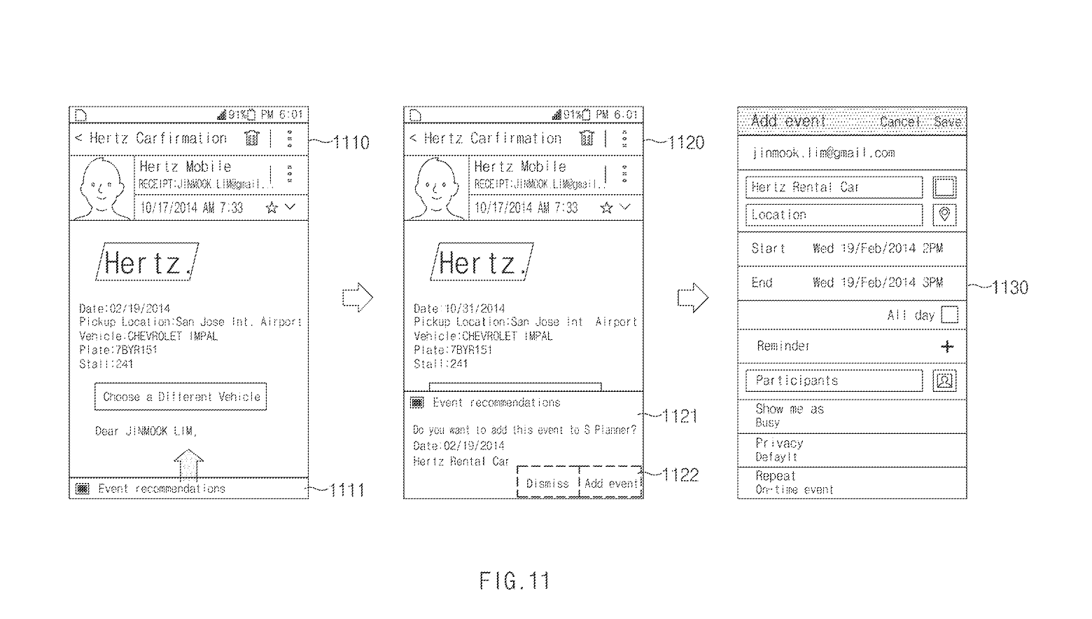

The connection app 720 may indicate an application which is provided with information analyzed (extracted) by the template 700 or is associated. For example, in case of a template to be applied to contents, such as a message, e-mail, and the like, received from the Korean Air, the connection app 720 may include the Korean Air official application. Furthermore, in case of a template to be applied to a message/e-mail associated with flight ticket reservation information, the connection app 720 may include a calendar application or a planner application as well as the Korean Air official application. That is, the connection app 720 may include a plurality of applications, and a menu for controlling connection with the applications and execution thereof may be provided in an appropriate format (UI) together with information extracted by the template 700. This will be described with reference to FIG. 11.

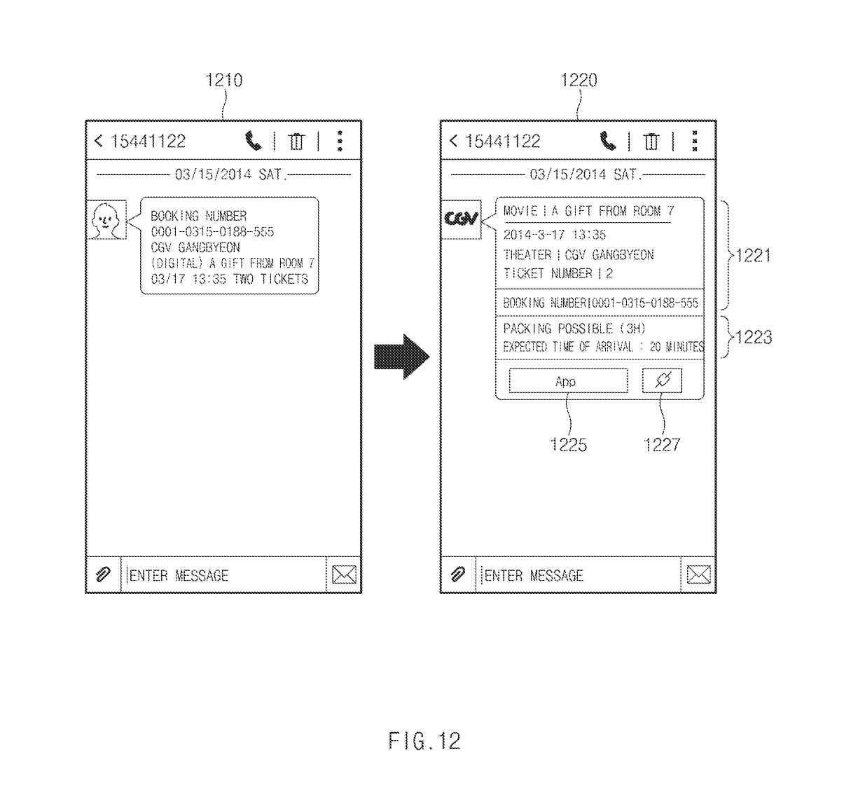

Meanwhile, the connection app 720 may be generally understood as being a connection item. According to various embodiments of the present disclosure, the connection app 720 may include a website and the like as well as an application. For example, in case of a template applicable to an SMS message providing movie reservation information, the connection item may include an official homepage of a corresponding movie or a website, such as “http://www.imdb.com/” or “http://www.rottentomatoes.com/”, as well as a movie associated application. An electronic device 400 may provide reconstructed information together with connection on the application and a connection item on the website. This will be described with reference to FIG. 12.

The template 700 may include a plurality of entities. According to various embodiments of the present disclosure, the entities may be hierarchically structured. For example, entity 1 (entity 740) may include entity 1-1 to entity 1-3 (entities 741, 742, and 743) as lower entities. Furthermore, the entity 1-3 (entity 743) may include entities 1-3-1 and 1-3-2 (entities 744 and 745) as lower entities. Lower entities (child entities) may include information of an upper entity (parent entity).

For example, the template 700 may extract flight time information (entity 1) from plane ticket reservation e-mail. The flight time information may have a departure time (entity 1-1), a flight time (entity 1-2), and an arrival time (entity 1-3). Furthermore, the departure time may have a local time (entity 1-3-1) and a departure point time (entity 1-3-2). According to various embodiments of the present disclosure, information corresponding to one entity may be constituted of a number of entities.

According to various embodiments of the present disclosure, the template 700 may include an essential entity among a plurality of entities. In the above-described exemplification, the departure time and the arrival time may be essential entities. Furthermore, entities corresponding to a flight name, a departure airport, and an arrival airport may be essential entities. However, entities corresponding to a flight time, a reservation number, a seat number, and the like may be general entities, not essential entities.

According to various embodiments of the present disclosure, even though an extractor 422 fails to extract a general entity (a log may be recorded), the extractor 422 may not determine such a case as failing to extract information using a template. However, in the case where the extractor 422 fails to extract at least one of essential entities, the extractor 422 may determine such a case as failing to extract information using a template. This will be described with reference to FIG. 9.

FIG. 8 illustrates an exemplification in which an entity value is extracted using node information and regular expression according to various embodiments of the present disclosure.

Referring to FIG. 8, an extractor 422 may extract an entity value corresponding to an entity 1-1 using node information 810. For example, in a template 700, the entity 1-1 may include extraction information indicating that an entity value is extracted according to node information (xPath) 820 “/table/tbody/tr[1]/td[1]/text( )”. The extractor 422 may extract a text (text( )) value at the first row tr[1] and the first column td1[1] of a table defined according to node information by a <table> tag, as an entity value of the entity 1-1. Referring to FIG. 8, the entity 1-1 840 may be a “departure airport” item, and an entity value corresponding to the entity 1-1 840 may be “INCHEON INTL” 830.

According to various embodiments of the present disclosure, text-based contents provided as an input may be a general text or may comply with a document object model (DOM). The template 700 may include node information on the DOM as extraction information for extracting information or a specific value from input contents. That is, the node information may indicate a specific position of a text-based contents structure. Referring to FIG. 8, a structure of a <table> tag may be exemplified, but various tag structures applicable to text-based contents such as xml, html, php, and the like, may be used. For example, node information may be organized using a tag such as <div>, <ul>, <ol>, <li>, or the like.

Continuing to refer to FIG. 8, the extractor 422 may extract an entity value corresponding to an entity 1-2 850 using a regular expression 860. For example, regular expression such as “d+” may indicate one or more numbers (one number if regular expression is “d”), and thus, “00561222026444” 870 may be extracted as an entity value of the entity 1-2 being a “reservation number” item.

According to various embodiments of the present disclosure, the node information and the regular expression may be used independently of each other or together. For example, the extractor 422 may obtain a character string of a corresponding node from text-based contents using node information and may apply regular expression to the character string to obtain an appropriate value. For example, if regular expression “d+” is applied when node information indicates that “a reservation number is 0123456789”, “0123456789” may be extracted from the node as an entity value.

FIG. 9 illustrates an entity extracting process according to various embodiments of the present disclosure.

Referring to FIG. 9, in operation 910, an extractor 422 may check an entity of an extraction target included in a template. In operation 910, the extractor 422 may check the number of entities included in a template, a hierarchical structure of entities, whether an entity is an essential entity, and the like.

In operation 920, the extractor 422 may obtain extraction information of each entity corresponding to an extraction target. Here, the extraction information may be node information indicating a specific position of a text-based contents structure or regular expression indicating a format of a text included in text-based contents. According to various embodiments of the present disclosure, the extraction information may include the node information and the regular expression.

If a plurality of entities is determined in operation 910 as having a hierarchical structure, extraction information of an upper entity obtained in operation 920 may be applied to extraction information of a lower entity (or extraction information of a lower entity includes extraction information of an upper entity). For example, in the case where text-based contents having five <table> structures are provided as an input text, an upper entity may indicate an item of a third <table> structure, and if a lower entity of the upper entity indicates an item at the second row and the third column of the <table>, extraction information of the lower entity (e.g., /tr[2]/td[3]) may include extraction information of the upper entity (e.g., /table[3]).

In operation 930, the extractor 422 may obtain an entity value corresponding to each entity based on the obtained extraction information. For example, the extractor 422 may obtain an entity value using node information and/or regular expression described with reference to FIG. 8.

In operation 940, the extractor 422 may determine whether extraction is performed with respect to all entities checked in operation 910. If extraction is performed with respect to all entities, in operation 950, the extractor 422 may determine whether essential entities all are extracted successfully. If all essential entities are extracted successfully, the process may proceed to operation C (e.g., providing reconstructed information based on an extraction result (operation 540 of FIG. 5)). If failing to extract at least a portion of the essential entities, in operation 970, the extractor 422 may determine such a case as failing to extract essential entities using a template. Also, a logger 423 may transfer a log on failure to a server 450.

If extraction on some entities is determined in operation 940 as being not yet performed, in operation 960, the extractor 422 may select a next entity and may extract an entity value based on extraction information of the selected entity. The above-described procedure may iterate until all entities are extracted.

FIG. 10 illustrates a log processing process according to extraction failure according to various embodiments of the present disclosure.

First, operation 670, that is, the case that information is not extracted because an appropriate template is not selected in deciding a template (information extraction failure) will be described. This case may correspond to a situation where metadata or a template satisfying a pre-condition is not stored at an electronic device 400. In operation 1010, a logger 423 may transfer a failure log to a server 450 and may together transfer a template request based on the transferred log. The template request may be performed by a template manager 424. The failure log may include metadata used to decide a template and pre-condition information of failed templates.

According to various embodiments of the present disclosure, the server 450 may decide a template to be provided to the electronic device 400, based on the failure log from the electronic device 400. For example, the server 450 may select a template, having a template key corresponding to metadata included in the failure log, from among templates stored at a storage unit 454 and may transfer an additional template of the stored templates, from which a template including the same pre-condition information as a failed template is excluded, to the electronic device 400.

In operation 1020, if successfully receiving the additional template, the electronic device 400 may proceed to operation B and may perform a process illustrated in FIG. 9 using the additional template. However, in the case where an additional template is not received from the server 450 (e.g., in the case where a template update is relatively recently provided to the electronic device 400 from the server 450), an additional template may be not received from the server 450. In this case, in operation 1030, if it is possible to provide a template update on the failure log, the electronic device 400 (e.g., a template manager 424) may provide a template immediately or may transfer template update reservation information requesting notification on a template update.

Next, operation 970, that is, the case of failing to extract an essential entity even though a template is selected will be described. This case may occur if a text-based contents provider (e.g., an e-mail/message sender) recently revises a contents format.

Also, a process performed in case of operation 670 may be similarly performed in case of a failure log of operation 970. First, in operation 1010, the logger 423 may transfer a failure log, including information on an essential entity not extracted, to the server 450. If a template updated with regard to the essential entity exists, the server 450 may provide the template to the electronic device 400 in response to the failure log. If an additional template is received in operation 1020, the process may proceed to operation B and the extractor 422 may perform a process of FIG. 9.

Second, a failure log may correspond to the case that extraction failure occurs even though metadata and a template satisfying a pre-condition item are stored at a storage unit 430 of the electronic device 400. In this case, the probability that an additional template is to be provided may be lower in comparison with a failure log of operation 670. Alternatively, the probability that an additional template is to be provided may be lower even in the case where extraction failure on an essential entity again occurs even though a process of FIG. 9 is performed using an additional template. In this case, a template update request may be transferred to the server 450 without requesting an additional template (operation 1030). In such a case, a failure log may be also transferred.

In the case of failing to decide a template or extract an essential entity, a process associated with a transfer of a failure log may be understood with respect to FIG. 10. Meanwhile, the electronic device 400 (a logger 423) may send a success log to the server 450 even though an entity is successfully extracted using a template. For example, in the case where positions of a departure time and an arrival time in an airplane ticket guide e-mail are changed at any time and are then provided, it may be possible to successfully extract all entities without an error using an existing template. In this case, however, information to be provided to a user may be information indicating that a departure time and an arrival time are switched. Accordingly, even in case of a success log, it may be necessary to determine whether a template is normally applied, using a sampling method and the like. In case of the success log, however, promptness may not be required or an error may not be fatal, unlike the case of the failure log. For this reason, the failure log may be immediately provided to the server 450; on the other hand, the success log may be transferred to the server 450 with a period.

A template stored at the storage unit 430 of the electronic device 400 may be consistently updated through communication with the server 450. According to various embodiments of the present disclosure, the server 450 may provide the electronic device 400 with an updated template periodically (e.g., at 3 A.M. every Sunday). Alternatively, in the case where a change on a user environment using a terminal (a terminal environment of a user) occurs, for example, in the events that a user installs a new application, that representative data accumulated and generated by users is transferred through, for example, a crowd sourcing method, that a template which is recently substantially downloaded is recommended, that a user directly selects and downloads a desired template, and that a user subscribes to a new site, the server 450 may provide a template associated with the change or a user may change a template associated with the change.

According to various embodiments of the present disclosure, as above described with reference to FIG. 6 or 9, a template update may be performed if the failure log occurs. For example, in the case of failing to decide a template, an addition template may be updated on the server 450. In this case, the server 450 may first provide an additional template associated with the failure log and may provide an updated template retained by the server 450 to the electronic device 400 at a point in time when the failure log is reported at a background level. The same process may be applied to the case when a template is successfully selected but extraction failure on an essential entity occurs.

FIG. 11 illustrates an exemplification in which reconstructed information is provided in the format of toast message according to various embodiments of the present disclosure.

Referring to FIG. 11, there is illustrated a screen 1110 on reservation information guide e-mail received from a car rental enterprise (e.g., Hertz). If the e-mail is received, a template manager 424 may decide a template fit to the e-mail, and an extractor 422 may extract information using the template. Referring to FIG. 11, notification may be provided that extracted information is placed at a bottom end area 111 of the screen 1110. A screen 1120 may be provided if a touch input for dragging the area 1111 from the bottom to the top is provided by a user.

The screen 1120 may be displayed in such a way that an area 1121, including information obtained by reconstructing entity values extracted from the e-mail, is overlaid on the e-mail screen 1110. The reconstructed information may only provide brief information, indicating that a car is rented from the Hertz Rental Car on Feb. 19, 2014, of the e-mail (text-based contents). Furthermore, the reconstructed information may further include an item on any other application to be linked to the reconstructed information. If an “Add event” item 1122 is selected, pieces of information extracted by a template may be automatically input to a schedule management application 1130.

An embodiment of FIG. 11 may be variously implemented through modification. For example, notification 1111 may not be provided on the screen 1110, but information 1121 reconstructed in the format of screen 1120 may be initially provided. Alternatively, if a notification area on the screen 1110 is selected, the reconstructed information may be provided in the form of a pop-up.

FIG. 12 illustrates an exemplification in which text-based contents are replaced with reconstructed information according to various embodiments of the present disclosure.

Referring to FIG. 12, a screen 1210 may indicate a movie reservation guide text message including information on a reservation number, a theater, a movie title, a show time, and the number of reserved tickets. According to various embodiments of the present disclosure, an electronic device 400 may extract information from the text message using an appropriate template and may replace the text message screen with a screen 1220 reconstructed using the extracted information. This may be very useful in the following cases: the case that it is impossible to recognize a very lengthy message (e.g., including guide messages such as “please enter theater 10 minutes ago” and “cancellation or refund is impossible 20 minutes ago”) on a screen of a smart phone at a time or the case that readability may be poor. According to various embodiments of the present disclosure, as described above, a control module 421 may replace a first screen (e.g., a screen 1210), based on text-based contents, with a second screen (e.g., a screen 1220) constructed with a format different from that of the first screen.

According to various embodiments of the present disclosure, reconstructed information may include information 1223, obtained from external or internal database of the electronic device 400, a remote server, and the like based on contents, as well as information 1221 obtained from contents. For example, the electronic device 400 may obtain and provide packing information (e.g., packing is possible or packing is possible at XX building) of a corresponding movie theater through an internet search method or a method for requesting (e.g., query) information at database (in such methods, the movie theater obtained from a corresponding text message is used as a keyword). Furthermore, the electronic device 400 may obtain, for example, a time (e.g., estimated time of arrival) taken to move to the movie theater from a current position, based on location information of the movie theater and current location information of the electronic device 400. The electronic device 400 may also provide an expected time of end of a movie, based on running time information of the movie which is obtained using both the movie and information on a show time, included in the information 1221 obtained from contents, as keywords.

Meanwhile, reconstructed information may include an information-associated application item 1225 (e.g., a CGV theater application, a schedule management application, and the like) and an external link item 1227 (e.g., movie official site, IMDB site, and the like) such as website connection. If each item is selected, reconstructed information (or information extracted by a template) may be provided or automatically input to a corresponding application, or connection to a website may be made according to a link.

According to various embodiments of the present disclosure, as described above, information which an application of the electronic device 400 obtains may be an image or image-based contents. For example, a received text message on the screen 1210 may be multimedia contents having the format of MMS including an image. In this case, as above described in operation 520 of FIG. 5, the electronic device 400 may convert the obtained MMS into a text and may analyze contents to provide a result including information included in the contents, information obtained from the contents, an application associated with the contents, a website capable of providing additional information with respect to the contents, and the like, as illustrated at the screen 1220.

According to various embodiments of the present disclosure, the electronic device 400 may share reconstructed information with any other electronic device as illustrated at the screen 1220. For example, the electronic device 400 may decide a target (e.g., an electronic device, a user account, and the like) to share reconstructed information, using a share menu included in the screen 1220. The share menu may be included in the reconstructed information, or the electronic device 400 may provide the share menu. For example, the share menu may be provided at the screen 1220 instead of the external link item 1227.

Since the screen 1220 is structured by a template, a layout of shared information may not be retained according to a type of electronic device receiving the shared information or a function supported by an electronic device, or the shared information may be damaged according thereto. In this case, when the share function is performed, the electronic device 400 may convert the reconstructed information into a general-purpose format (e.g., html, xml, and the like) to provide it to any other electronic device. In contrast, if receiving information of a general-purpose format from an external device, the electronic device 400 may restore the received information to a template. For example, a document structure of information provided from an external device may be compared with a document structure which information obtained by a template has when converted into a general-purpose format; if the document structures correspond to each other or similarity between the document structures is above a level, the electronic device 400 may decide the template as a template fit to information provided from the external device. According to the above-described configuration, the electronic device 400 may transform a function (e.g., in the case where an external device uses a safari application as an external link item (e.g., 1227) but the electronic device 400 supports not the safari application but a chrome browser application), which is executed on an external device but is not supported on the electronic device 400, so as to be supported through a corresponding configuration at the electronic device 400.

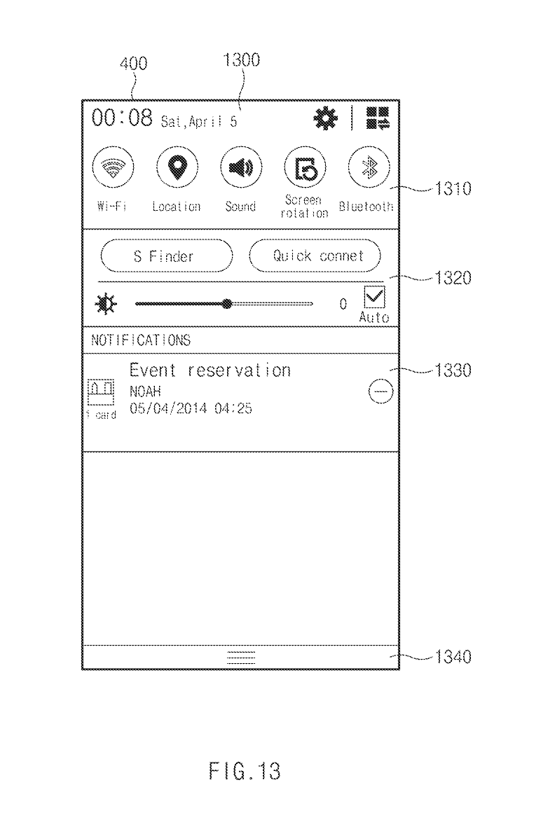

FIG. 13 illustrates an exemplification in which reconstructed information is provided at a notification bar area according to various embodiments of the present disclosure.

For example, even though a user does not consistently check a screen of an electronic device 400, the electronic device 400 may decide a template applicable to various types of messages and e-mails received and may extract and reconstruct information using the selected template. The reconstructed information may be provided at a notification bar area. For example, if a user provides an input dragged from the top to the bottom of a display of the electronic device 400, a screen 1300 including the notification bar area may be displayed.

The screen 1300 may include a toggle area 1310 indicating a current network or activated service state of the electronic device 400, a setting area 1320, including various settings such as brightness and the like, and a notification area 1330. If the notification area 1330 is selected by a user, the electronic device 400 may allow a message/e-mail, functioning as an input text of reconstructed information, to be displayed at the notification area 1330.

Besides above-described exemplifications, information extracted using a template may be provided in various methods. For example, a wearable device such as a smart watch may include a display smaller than that of a coupled smart phone. According to various embodiments of the present disclosure, since including important information, information extracted using a template may be simply provided. For this reason, it may be efficient to provide original contents at the smart phone and information, reconstructed using a template, at the wearable device coupled with the smart phone. For example, a setting may be made so as to output received (obtained) message/e-mail/website contents at the smart phone and to output information, extracted by applying a template to the contents, at the wearable device coupled with the smart phone through a BT or the like.

According to various embodiments of the present disclosure, a user may want to receive notification if a bulletin board message including a keyword is hung up on a specific website. For example, if a bulletin board message including a keyword “Audi A7” is registered on a used card transaction website, the electronic device 400 may provide notification. After first checking fundamental information such as price, date of manufacture, detailed model, mileage, accident history, and the like, a user may check additional detailed information (e.g., tuning, rest of the warranty period, and the like). However, if receiving notification to check a corresponding bulletin board message, a user may be provided with information not associated with a car or not interested, thereby causing a decrease in efficiency of obtaining information.

According to various embodiments of the present disclosure, the electronic device 400 may use, as an input text (text-based contents), a bulletin board message registered at a corresponding website through an appropriate template, may extract user-interested information using an appropriate template, and may provide the extracted information using a new format. Information reconstructed to a new format may be provided, for example, through a browser or a specific application that the electronic device 400 provides. As another example, information reconstructed to a new format may be provided at a notification bar area of the electronic device 400. In this case, if a user selects information provided at the notification bar area, it may be possible to connect to a bulletin board message of a relevant website corresponding to the information.

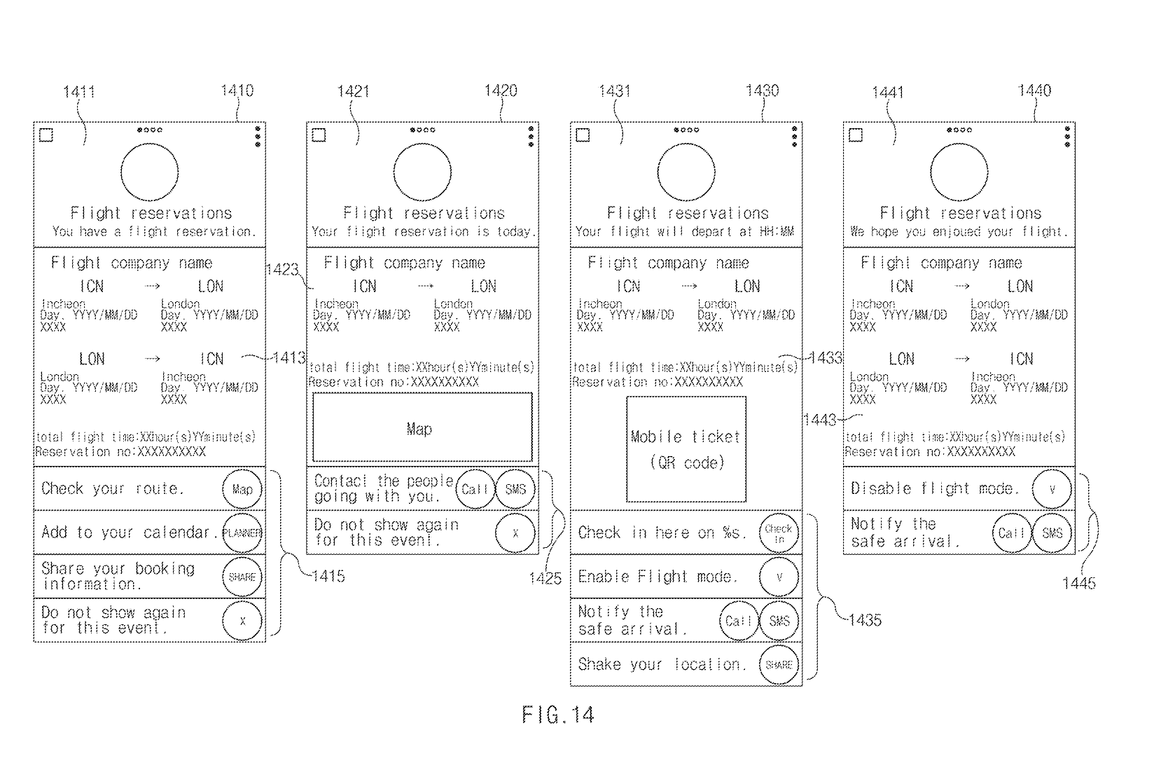

FIG. 14 illustrates an exemplification in which flight reservation information is provided according to various embodiments of the present disclosure.

Referring to FIG. 14, if receiving an airplane ticket reservation guide mail, an electronic device 400 may provide screens 1410, 1420, 1430, and 1440 including appropriately reconstructed information. According to various embodiments of the present disclosure, even though obtaining the same contents, for example, the same airplane ticket reservation guide mail, the electronic device 400 may provide screens variable according to a situation. For example, the electronic device 400 may compare a schedule included in a mail with a current time to use different templates or to change screen construction at the same template.

According to various embodiments of the present disclosure, the screen 1410 may illustrate a screen corresponding to the case that a departure schedule does not arrive. Such a screen may be automatically provided in checking e-mail, in the case of selecting a toast message described with reference to FIG. 11, in the case of executing an application (e.g., smart assistant application) for extracting information from contents to provide it to a user, in case of a lock or toggle screen of an electronic device, and the like.

According to various embodiments of the present disclosure, the screen 1410 may include information (e.g., you have a flight reservation.) that an information-associated message 1411, for example, a reserved plane ticket exists. Furthermore, the screen 1410 may include general information (e.g., a departure/arrival airport, a departure/arrival time, total travel time, and the like), associated with a travel, from among extracted items. The screen 1410 may also include information 1415 on various services (e.g., an associated application). The information 1415 on the services may include, for example, a map application showing a travel route, a schedule application (e.g., a planner, a calendar, and the like) for an input of schedule information, or a share function for sharing reservation information with others or a service such as a social networking service (SNS). According to various embodiments of the present disclosure, a guide message such as a screen 1410 may be provided to a user at a specified time daily, or the information 1415 on the services may include a menu for requesting stopping providing of a notification message.

According to various embodiments of the present disclosure, a screen 1420 may be provided if a boarding date of a flight matches with today's date. For example, the screen 1420 may be provided instead of the screen 1410 when a user checks e-mail and selects a toast message popped up in checking the e-mail.

The screen 1420 may include a message 1421 associated with information. In the screen 1420, the message 1421 may include, for example, information that your flight reservation is today. According to various embodiments of the present disclosure, the above-described information 1413 may provide information 1415 organized to be fit to a situation. For example, the information 1415 may provide one-way information (today departure schedule) instead of information on a shuttle flight and may provide route information (e.g., map) until a departure airport (e.g., Incheon Airport (ICN)). Furthermore, the electronic device 400 may analyze e-mail to extract companion information 1423 and may provide an application, which compares the extracted companion information with an address book of the electronic device 400 to get in touch with a companion (e.g., a telephone, a text message, and the like), together with information 1425 on an associated service. Although not illustrated, also, the information 1425 may include today's weather information (or a weather application) of a region near a departure airport.

The screen 1430 may be provided when a current time is within a reference time (e.g., three hours) from a boarding time, when the electronic device 400 is currently determined as connecting to an access point (AP) of a departure airport, or when location information (e.g., GPS information) of the electronic device 400 corresponds to that of a region near the departure airport. In the screen 1430, a message 1431 may provide information (e.g., your flight will depart at HH:MM) on today's flight departure time (or check-in deadline). According to various embodiments of the present disclosure, the information 1433 may also include a mobile ticket or a QR code for check-in. According to various embodiments of the present disclosure, information 1435 on an associated service may include an airline mobile check-in function (e.g., an airline or an airport application), a flight mode activation function, an arrival message providing function, a current location sharing function of the electronic device 400, and the like.

The screen 1440 may be provided after a user of the electronic device 400 arrives at a destination airport. For example, the screen 1440 may be provided if an expected time of arrival elapses or if location information of the electronic device 400 corresponds to a destination. In this case, a message 1441 may include a travel guide message (e.g., we hope you enjoyed your flight). Furthermore, according to various embodiments of the present disclosure, information 1443 may provide the whole schedule information like the information 1413 or may provide information on a return flight (e.g., LON-ICN). Also, information on a service may include a function for releasing a flight mode or providing an arrival message 1445.

According to various embodiments of the present disclosure, a method for providing information at an electronic device may include obtaining contents, deciding one or more extraction items on the contents, extracting a value, corresponding to the extraction item, from the contents, and providing reconstructed information including the extraction result.

According to various embodiments of the present disclosure, the deciding of one or more extraction items may include deciding a template to be applied to the contents and deciding a plurality of extraction items included in the template.

According to various embodiments of the present disclosure, the deciding of a template may include deciding metadata associated with the contents and selecting at least one template corresponding to the metadata. Furthermore, the metadata may include at least one of information on an application associated with the contents or source information of the contents. Also, the metadata may include a language set at the electronic device. In this case, the providing of reconstructed information may provide the reconstructed information by the set language.

According to various embodiments of the present disclosure, the template may include a pre-condition item. The deciding of a template may further include deciding a template, in which the pre-condition item is satisfied by the contents, from among the at least one template selected.

According to various embodiments of the present disclosure, the extracting may include obtaining extraction information of the extraction item and extracting a value corresponding to the extraction item based on the obtained extraction information. Furthermore, the extraction information may include at least one of node information indicating a specific position at a structure of the contents or regular expression indicating a format of a text included in the contents.

According to various embodiments of the present disclosure, the plurality of extraction items may include at least one essential extraction item. The method may further include transferring, if extraction on at least a portion of the essential extraction item fails, a failure log to a server.

According to various embodiments of the present disclosure, the deciding of a template may include transferring, if failing to decide a template, a failure log to a server, receiving at least one additional template from the server in response to the transferred failure log, and deciding at least one of the at least one additional template as a template for extracting information included in the contents. Also, the method may include transferring, if no additional template is received from the server, a template update reservation request requesting a template or notification provision when an additional template on the failure log is provided from the server.

According to various embodiments of the present disclosure, the method may further include transferring a log on the extraction result to a server periodically.

According to various embodiments of the present disclosure, the providing of the reconstructed information may include replacing a first screen, based on the contents, with a second screen constructed to have a format different from the first screen. In this case, the second screen may include the reconstructed information.

Also, the providing of the reconstructed information may include at least one of outputting the reconstructed information to at least a portion of a first screen, based on the contents, in an overlay manner or outputting the reconstructed information to a notification bar area. In this case, the reconstructed information may include at least one of other application item associated with the reconstructed information or an external link item.

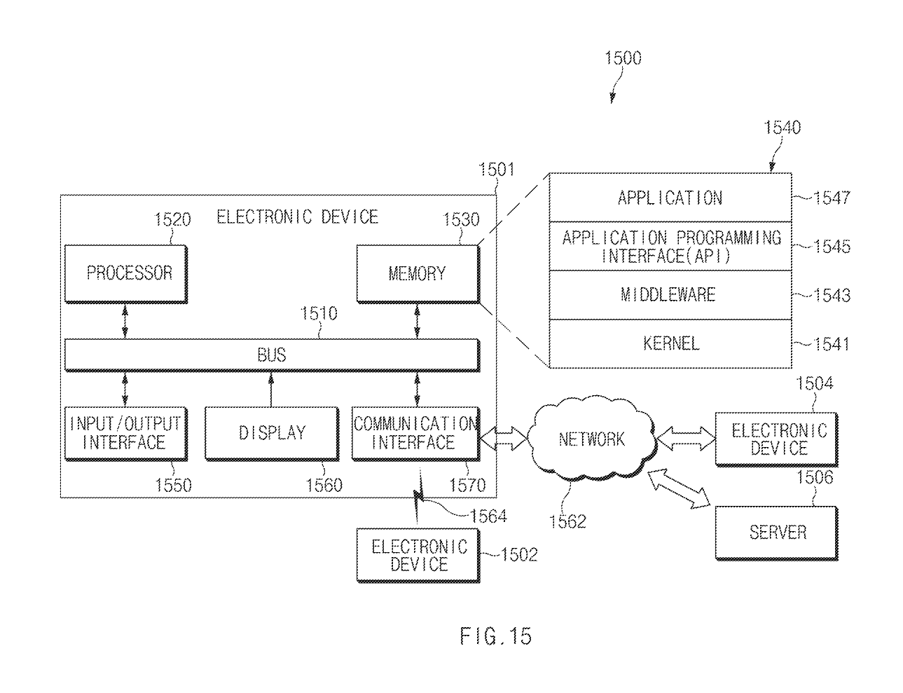

FIG. 15 is a diagram illustrating an electronic device in a network environment according to various embodiments of the present disclosure.

Referring to FIG. 15, there is illustrated an electronic device 1501 in a network environment 1500 according to various embodiments of the present disclosure. An electronic device 1501 may include a bus 1510, a processor 1520, a memory 1530, an input/output interface 1550, a display 1560, and a communication interface 1570. According to various embodiments of the present disclosure, the electronic device 1501 may not include at least one of the above-described components or may further include other component(s). The electronic device 1501 may correspond to, for example, the above-described user terminal 100 or 200 or electronic device 400.

The bus 1510 may interconnect the above-described components 1510 to 1570 and may be a circuit for conveying communications (e.g., a control message and/or data) among the above-described components.

The processor 1520 may include one or more of a CPU, an AP, or a communication processor (CP). The processor 1520 may perform, for example, data processing or an operation associated with control or communication of at least one other component(s) of the electronic device 1501. The processor 1520 may correspond to the above-described control module 421. According to various embodiments of the present disclosure, the processor 1520 may perform functions of the control module 421, a logger 423, an extractor 422, and a template manager 424.

The memory 1530 may include a volatile and/or nonvolatile memory. The memory 1530 may store instructions or data associated with at least one other component(s) of the electronic device 1501. Furthermore, the memory 1530 may store templates used by the template manager 424 or may perform a function of a storage unit 430 where extraction success/failure recorded by the logger 423 are stored. According to various embodiments of the present disclosure, the memory 1530 may store software and/or a program 1540. The memory 1530 may include, for example, a kernel 1541, a middleware 1542, an application programming interface (API) 1545, and/or an application (or an application program) 1547. At least a portion of the kernel 1541, the middleware 1543, or the API 1545 may be called an “operating system (OS)”.

The kernel 1541 may control or manage system resources (e.g., the bus 1510, the processor 1520, the memory 1530, and the like) that are used to execute operations or functions of other programs (e.g., the middleware 1542, the API 1545, and the application program 1547). Furthermore, the kernel 1541 may provide an interface that allows the middleware 1543, the API 1545, or the application program 1547 to access discrete components of the electronic device 1501 so as to control or manage system resources.

The middleware 1543 may perform a mediation role such that the API 1545 or the application program 1547 communicates with the kernel 1541 to exchange data. Furthermore, with regard to task requests received from the application program 1547, for example, the middle ware 1543 may perform a control (e.g., scheduling or load balancing) on a task request using a method of assigning the priority, which makes it possible to use a system resource (e.g., the bus 1510, the processor 1520, the memory 1530, or the like) of the electronic device 1501, to at least one application.

The API 1545 may be an interface through which the application program 1547 controls a function provided by the kernel 1541 or the middleware 1543, and may include, for example, at least one interface or function (e.g., an instruction) for a file control, a window control, image processing, a character control, or the like.

The input/output (I/O) interface 1550 may transmit an instruction or data, input from a user or another external device, to other component(s) of the electronic device 1501. Furthermore, the I/O interface 1550 may output an instruction or data, received from other component(s) of the electronic device 1501, to a user or another external device.

The display 1560 may include, for example, a liquid crystal display (LCD), a light-emitting diode (LED) display, an organic LED (OLED) display, or a microelectromechanical systems (MEMS) display, or an electronic paper display. The display 1560 may display, for example, various contents (e.g., a text, an image, a video, an icon, a symbol, and the like) to a user. The display 1560 may include a touch screen and may receive, for example, a touch, gesture, proximity, or hovering input using an electronic pen or a portion of a user's body.

The communication interface 1570 may establish communication 1564 between the electronic device 1501 and an external electronic device (e.g., a first external electronic device 1502, a second external electronic device 1504, or a server 1506). For example, the communication interface 1570 may be connected to a network 1562 through wireless communication or wired communication to communicate with the external device (e.g., a second external electronic device 1504 or a server 1506).

The wireless communication may include at least one of, for example, LTE, LTE-A, code division multiple access (CDMA), wideband code division multiple access (WCDMA), universal mobile telecommunications system (UMTs), wireless broadband (WiBro), global system for mobile communications (GSM), or the like, as cellular communication protocol. The wired communication may include at least one of, for example, a universal serial bus (USB), a high definition multimedia interface (HDMI), a recommended standard-232 (RS-232), or a plain old telephone service (POTS). The network 1562 may include at least one of telecommunications networks, for example, a computer network (e.g., LAN or wide area network (WAN)), an internet, or a telephone network.

Each of the first and second external electronic devices 1502 and 1504 may be a device of which the type is different from or the same as that of the electronic device 1501. According to an embodiment of the present disclosure, the server 1506 may include a group of one or more servers. According to various embodiments of the present disclosure, all or a part of operations that the electronic device 1501 will perform may be executed by another or plural electronic devices (e.g., the electronic devices 1502 and 1504 and the server 1506). According to an embodiment of the present disclosure, in the case where the electronic device 1501 executes any function or service automatically or in response to a request, the electronic device 1501 may not perform the function or the service internally, but, alternatively additionally, it may request at least a portion of a function associated with the electronic device 1501 at other device (e.g., the electronic device 1502 or 1504 or the server 1506). The other electronic device (e.g., the electronic device 1502 or 1504 or the server 1506) may execute the requested function or additional function and may transmit the execution result to the electronic device 1501. The electronic device 1501 may provide the requested function or service using the received result or may additionally process the received result to provide the requested function or service. To this end, for example, cloud computing, distributed computing, or client-server computing may be used.

According to various embodiments of the present disclosure, the electronic device 1501 may provide the external electronic device 1504 with reconstructed information based on information extracted from contents. In this case, the electronic device 1501 may convert the reconstructed information into a general-purpose format to provide it to the external electronic device 1504.

According to various embodiments of the present disclosure, the electronic device 1501 may transfer success or failure log on contents extraction using a template to the server 1506. Also, the electronic device 1501 may periodically experience a template update from the server 1506. Furthermore, the electronic device 1501 may immediately receive an updated template from the server 1506 in response to a log transfer on extraction failure.

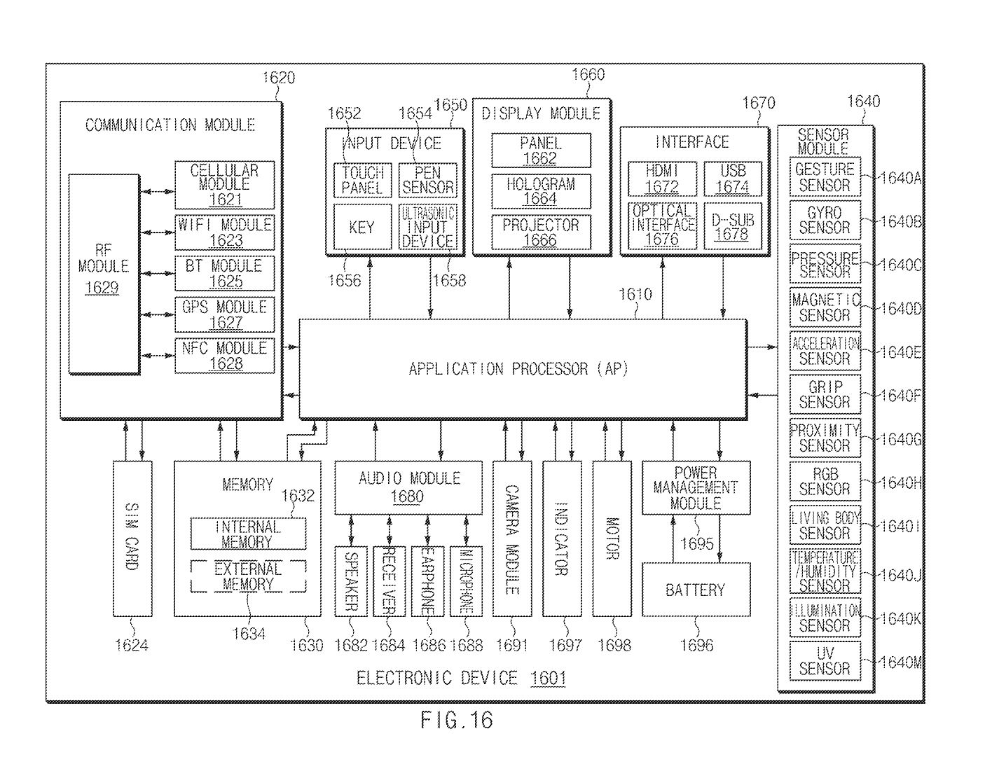

FIG. 16 is a block diagram 1600 illustrating an electronic device 1601 according to various embodiments of the present disclosure.

Referring to FIG. 16, an electronic device 1601 may include all or a part of an electronic device 1501 illustrated in FIG. 15. The electronic device 1601 may include one or more AP 1610, a communication module 1620, a subscriber identification module (SIM) card 1624, a memory 1630, a sensor module 1640, an input device 1650, a display 1660, an interface 1670, an audio module 1680, a camera module 1691, a power management module 1695, a battery 1696, an indicator 1697, and a motor 1698.

The AP 1610 may drive, for example, an (OS or an application to control a plurality of hardware or software components connected to the AP 1610 and may process and compute a variety of data including multimedia data. The AP 1610 may be implemented with a SoC, for example. According to an embodiment of the present disclosure, the AP 1610 may further include a graphics processing unit (GPU) (not illustrated) and/or an image signal processor. The communication module 1620 may include a part (e.g., a cellular module 1621) of components illustrated in FIG. 2. The AP 1610 may load instructions or data, received from at least one of other components (e.g., a nonvolatile memory), onto a volatile memory and may store various data at a nonvolatile memory.

The communication module 1620 may be configured to be the same as or similar to a communication interface 1570 illustrated in FIG. 15. The communication module 1620 may include a cellular module 1621, a Wi-Fi module 1623, a BT module 1625, a GPS module 1627, a NFC module 1628, and a radio frequency (RF) module 1629.

The cellular module 1621 may provide voice communication, video communication, a character service, an Internet service, and the like through a communication network. According to an embodiment of the present disclosure, the cellular module 1621 may perform discrimination and authentication of an electronic device within a communication network using a SIM (e.g., a SIM card 1624), for example. According to an embodiment of the present disclosure, the cellular module 1621 may perform at least a portion of functions that the AP 1610 provides. According to an embodiment of the present disclosure, the cellular module 1621 may include a CP.

Each of the Wi-Fi module 1623, the BT module 1625, the GPS module 1627, and the NFC module 1628 may include a processor for processing data exchanged through a corresponding module, for example. According to various embodiments of the present disclosure, at least a portion (e.g., two or more components) of the cellular module 1621, the Wi-Fi module 1623, the BT module 1625, the GPS module 1627, and the NFC module 1628 may be included within one integrated Circuit (IC) or an IC package.

The RF module 1629 may transmit and receive data, for example, a communication signal (e.g., an RF signal). The RF module 1629 may include a transceiver, a power amplifier module (PAM), a frequency filter, low noise amplifier (LNA), an antenna, or the like. According to various embodiments of the present disclosure, at least one of the cellular module 1621, the Wi-Fi module 1623, the BT module 1625, the GPS module 1627, or the NFC module 1628 may transmit and receive an RF signal through a separate RF module.

The SIM card 1624 may include, for example, a card and/or embedded SIM that includes a SIM and may include unique identify information (e.g., IC card identifier (ICCID)) or subscriber information (e.g., integrated mobile subscriber identity (IMSI)).

The memory 1630 may include an embedded memory 1632 or an external memory 1634. For example, the embedded memory 1632 may include at least one of a volatile memory (e.g., a dynamic random access memory (DRAM), a static RAM (SRAM), or a synchronous DRAM (SDRAM)), a nonvolatile memory (e.g., a one-time programmable read only memory (OTPROM), a programmable ROM (PROM), an erasable and programmable ROM (EPROM), an electrically erasable and programmable ROM (EEPROM), a mask ROM, a flash ROM, a not and (NAND) flash memory, or a not or (NOR) flash memory), a hard drive, or a solid state drive (SSD).

The external memory 1634 may include a flash drive, for example, compact flash (CF), secure digital (SD), micro-SD, mini-SD, extreme digital (xD) or a memory stick. The external memory 1634 may be functionally and/or physically connected to the electronic device 1601 through various interfaces.

The sensor module 1640 may measure a physical quantity or may detect an operation state of the electronic device 1601. The sensor module 1640 may convert the measured or detected information to an electric signal. Generally or additionally, the sensor module 1640 may include at least one of a gesture sensor 1640A, a gyro sensor 1640B, a pressure sensor 1640C, a magnetic sensor 1640D, an acceleration sensor 1640E, a grip sensor 1640F, a proximity sensor 1640G, a color sensor 1640H (e.g., red, green, blue (RGB) sensor), a living body sensor 1640I, a temperature/humidity sensor 1640J, an illuminance sensor 1640K, or an UV sensor 1640M. Although not illustrated, additionally or generally, the sensor module 1640 may further include, for example, an E-nose sensor, an electromyography sensor (EMG) sensor, an electroencephalogram (EEG) sensor, an electrocardiogram (ECG) sensor, a photoplethysmographic (PPG) sensor, an infrared (IR) sensor, an iris sensor, a fingerprint sensor, and the like. The sensor module 1640 may further include a control circuit for controlling at least one or more sensors included therein. According to various embodiments of the present disclosure, the electronic device 1601 may further include a processor which is a part of the AP 1610 or independent of the AP 1610 and is configured to control the sensor module 1640. The processor may control the sensor module 1640 when the AP 1610 remains at a sleep state.

The input device 1650 may include a touch panel 1652, a (digital) pen sensor 1654, a key 1656, or an ultrasonic input unit 1658. The touch panel 1652 may use at least one of capacitive, resistive, infrared and ultrasonic detecting methods. Also, the touch panel 1652 may further include a control circuit. The touch panel 1652 may further include a tactile layer. In this case, the touch panel 1652 may provide a tactile reaction to a user.

The (digital) pen sensor 1654 may be a part of a touch panel or may include a separate sheet for recognition. The key 1656 may include, for example, a physical button, an optical key, a keypad, and the like. The ultrasonic input device 1658, which is an input device for generating an ultrasonic signal, may enable the electronic device 1601 to sense a sound wave through a microphone (e.g., a microphone 1688) so as to identify data.

The display 1660 (e.g., a display 1560) may include a panel 1662, a hologram device 1664, or a projector 1666. The panel 1662 may be configured to be the same as or similar to a display 1560 illustrated in FIG. 15. The panel 1662 may be, for example, flexible, transparent or wearable. The panel 1662 and the touch panel 1652 may be integrated into a single module. The hologram device 1664 may display a stereoscopic image in a space using a light interference phenomenon. The projector 1666 may project light onto a screen so as to display an image. The screen may be arranged in the inside or the outside of the electronic device 1601. According to an embodiment of the present disclosure, the display 1660 may further include a control circuit for controlling the panel 1662, the hologram device 1664, or the projector 1666.

The interface 1670 may include, for example, an HDMI 1672, a USB 1674, an optical interface 1676, or a D-subminiature (D-sub) 1678. The interface 1670 may be included, for example, in a communication interface 1570 illustrated in FIG. 15. Additionally or generally, the interface 1670 may include, for example, a mobile high definition link (MHL) interface, a SD card/multi-media card (MMC) interface, or an infrared data association (IrDA) standard interface.

The audio module 1680 may convert a sound and an electric signal in dual directions. At least a portion of the audio module 1680 may be included, for example, in an input/output interface 1550 illustrated in FIG. 15. The audio module 1680 may process, for example, sound information that is input or output through a speaker 1682, a receiver 1684, an earphone 1686, or a microphone 1688.

The camera module 1691 for shooting a still image or a video may include, for example, at least one image sensor (e.g., a front sensor or a rear sensor), a lens (not illustrated), an image signal processor (ISP, not illustrated), or a flash (e.g., an LED or a xenon lamp, not illustrated).

The power management module 1695 may manage, for example, power of the electronic device 1601. According to an embodiment of the present disclosure, a power management IC (PMIC) a charger IC, or a battery or fuel gauge may be included in the power management module 1695. The PMIC may have a wired charging method and/or a wireless charging method. The wireless charging method may include, for example, a magnetic resonance method, a magnetic induction method or an electromagnetic method, and may further include a coil loop, a resonant circuit, a rectifier, and the like. The battery gauge may measure, for example, a remaining capacity of the battery 1696 and a voltage, current or temperature thereof while the battery is charged. The battery 1696 may include, for example, a rechargeable battery or a solar battery.

The indicator 1697 may display a specific state of the electronic device 1601 or a part thereof (e.g., the AP 1610), such as a booting state, a message state, a charging state, and the like. The motor 1698 may convert an electrical signal into a mechanical vibration and may generate vibration or a haptic effect. Although not illustrated, a processing device (e.g., a GPU) for supporting a mobile TV may be included in the electronic device 1601. The processing device for supporting a mobile TV may process media data according to the standards of digital multimedia broadcasting (DMB), digital video broadcasting (DVB) or media flow.

Each of the above-mentioned elements of the electronic device according to various embodiments of the present disclosure may be configured with one or more components, and the names of the elements may be changed according to the type of the electronic device. The electronic device according to various embodiments of the present disclosure may include at least one of the above-mentioned elements, and some elements may be omitted or other additional elements may be added. Furthermore, some of the elements of the electronic device according to various embodiments of the present disclosure may be combined with each other so as to form one entity, so that the functions of the elements may be performed in the same manner as before the combination.

According to various embodiments of the present disclosure, an electronic device may include a control module configured to obtain contents, and an information extraction module configured to decide one or more extraction items on the contents and to extract a value corresponding to the extraction item. Here, the control module may provide reconstructed information including the extraction result.

According to various embodiments of the present disclosure, the electronic device may further include a template manager configured to decide a template to be applied to the contents. In this case, the information extraction module may decide a plurality of extraction items included in the template.

According to various embodiments of the present disclosure, also, the reconstructed information may be provided to a wearable device coupled with the electronic device.

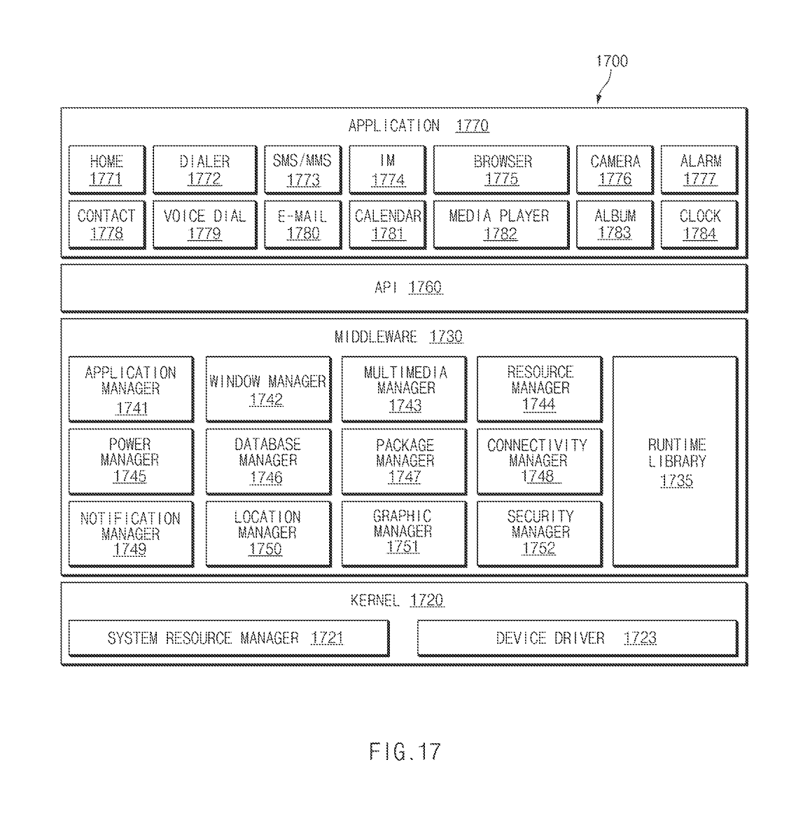

FIG. 17 illustrates a block diagram 1700 of a program module 1710 according to various embodiments of the present disclosure.

Referring to FIG. 17, a program module 1710 (e.g., a program 1540) may include an OS to control resources relevant to an electronic device (e.g., an electronic device 1501), and/or diverse applications (e.g., an application 410, an application program 1547, and the like) driven on the OS. The OS may be, for example, android, iOS, windows, symbian, tizen, or bada.

The program module 1710 may include a kernel 1720, a middleware 1730, an application programming interface (API) 1760, and/or an application 1770. At least a part of the program module 1710 may be preloaded on an electronic device or may be downloadable from a server (e.g., a server 1506).

The kernel 1720 (e.g., a kernel 1541 of FIG. 15) may include, for example, a system resource manager 1721 or a device driver 1723. The system resource manager 1721 may perform control, allocation, or retrieval of system resources. According to an embodiment of the present disclosure, the system resource manager 1721 may include a process managing part, a memory managing part, or a file system managing part. The device driver 1723 may include, for example, a display driver, a camera driver, a BT driver, a common memory driver, an USB driver, a keypad driver, a Wi-Fi driver, an audio driver, or an inter-process communication (IPC) driver.

The middleware 1730 may provide, for example, a function which the application 1770 needs in common, or may provide diverse functions to the application 1770 through the API 1760 to allow the application 1770 to efficiently use limited system resources of the electronic device. According to an embodiment of the present disclosure, the middleware 1730 (e.g., a middleware 1543) may include at least one of a runtime library 1735, an application manager 1741, a window manager 1742, a multimedia manager 1743, a resource manager 1744, a power manager 1745, a database manager 1746, a package manager 1747, a connectivity manager 1748, a notification manager 1749, a location manager 1750, a graphic manager 1751, or a security manager 1752.

The runtime library 1735 may include, for example, a library module which is used by a compiler to add a new function through a programming language while the application 1770 is being executed. The runtime library 1735 may perform input/output management, memory management, or capacities about arithmetic functions.

The application manager 1741 may manage, for example, a life cycle of at least one application of the application 1770. The window manager 1742 may manage a GUI resource which is used in a screen. The multimedia manager 1743 may identify a format necessary for playing diverse media files, and may perform encoding or decoding of media files by using a codec suitable for the format. The resource manager 1744 may manage resources such as a storage space, memory, or source code of at least one application of the application 1770.

The power manager 1745 may operate, for example, with a basic input/output system (BIOS) to manage a battery or power, and may provide power information for an operation of an electronic device. The database manager 1746 may generate, search for, or modify database which is to be used in at least one application of the application 1770. The package manager 1747 may install or update an application which is distributed in the form of package file.

The connectivity manager 1748 may manage, for example, wireless connection such as Wi-Fi or BT. The notification manager 1749 may display or notify an event such as arrival message, promise, or proximity notification in a mode that does not disturb a user. The location manager 1750 may manage location information of an electronic device. The graphic manager 1751 may manage a graphic effect that is provided to a user, or manage a user interface relevant thereto. The security manager 1752 may provide a general security function necessary for system security or user authentication. According to an embodiment of the present disclosure, in the case where an electronic device (e.g., an electronic device 1501) includes a telephony function, the middleware 1730 may further includes a telephony manager for managing a voice or video call function of the electronic device.

The middleware 1730 may include a middleware module that combines diverse functions of the above-described components. The middleware 1730 may provide a module specialized to each OS kind to provide differentiated functions. Additionally, the middleware 1730 may remove a part of the preexisting components, dynamically, or may add a new component thereto.

The API 1760 (e.g., an API 1545) may be, for example, a set of programming functions and may be provided with a configuration which is variable depending on an OS. For example, in the case where an OS is the android or the iOS, it may be permissible to provide one API set per platform. In the case where an OS is the tizen, it may be permissible to provide two or more API sets per platform.

The application 1770 (e.g., an application program 1547) may include, for example, one or more applications capable of providing functions for a home 1771, a dialer 1772, an SMS/MMS 1773, an instant message (IM) 1774, a browser 1775, a camera 1776, an alarm 1777, a contact 1778, a voice dial 1779, an e-mail 1780, a calendar 1781, a media player 1782, am album 1783, and a timepiece 1784, or for offering health care (e.g., measuring an exercise quantity or blood sugar) or environment information (e.g., atmospheric pressure, humidity, or temperature).

According to an embodiment of the present disclosure, the application 1770 may include an application (hereinafter referred to as “information exchanging application” for descriptive convenience) to support information exchange between the electronic device (e.g., an electronic device 1501) and an external electronic device (e.g., an electronic device 1502 or 1504). The information exchanging application may include, for example, a notification relay application for transmitting specific information to the external electronic device, or a device management application for managing the external electronic device.

For example, the information exchanging application may include a function of transmitting notification information, which arise from other applications (e.g., applications for SMS/MMS, e-mail, health care, or environmental information), to an external electronic device (e.g., an electronic device 1502 or 1504). Additionally, the information exchanging application may receive, for example, notification information from an external electronic device and provide the notification information to a user. The device management application may manage (e.g., install, delete, or update), for example, at least one function (e.g., turn-on/turn-off of an external electronic device itself (or a part of components) or adjustment of brightness (or resolution) of a display) of the external electronic device (e.g., an electronic device 1504) which communicates with the electronic device, an application running in the external electronic device, or a service (e.g., a call service or a message service) provided from the external electronic device.

According to an embodiment of the present disclosure, the application 1770 may include an application (e.g., a health care application) which is assigned in accordance with an attribute (e.g., an attribute of a mobile medical device as a kind of electronic device) of the external electronic device (e.g., an electronic device 1502 or 1504). According to an embodiment of the present disclosure, the application 1770 may include an application which is received from an external electronic device (e.g., a server 1506 or an electronic device 1502 or 1504). According to an embodiment of the present disclosure, the application 1770 may include a preloaded application or a third party application which is downloadable from a server. The component titles of the program module 1710 according to the embodiment of the present disclosure may be modifiable depending on kinds of OSs.

According to various embodiments of the present disclosure, at least a part of the program module 1710 may be implemented in software, firmware, hardware, or a combination of at least two or more combinations thereof. At least a part of the program module 1710 may be implemented (e.g., executed), for example, by a processor (e.g., an AP 1610). At least a part of the program module 1710 may include, for example, a module, a protein, a set of instructions, or a process for performing one or more functions.

The term “module” used herein may represent, for example, a unit including one or more combinations of hardware, software and firmware. The term “module” may be interchangeably used with the terms “unit”, “logic”, “logical block”, “component” and “circuit”. The “module” may be a minimum unit of an integrated component or may be a part thereof. The “module” may be a minimum unit for performing one or more functions or a part thereof. The “module” may be implemented mechanically or electronically. For example, the “module” according to various embodiments of the present disclosure may include at least one of an application-specific IC (ASIC) chip, a field-programmable gate array (FPGA), and a programmable-logic device for performing some operations, which are known or will be developed.

According to various embodiments of the present disclosure, at least a portion of an apparatus (e.g., modules or functions thereof) or a method (e.g., operations) according to various embodiments of the present disclosure, for example, may be implemented by instructions stored in a non-transitory computer-readable storage media in the form of a programmable module. The instruction, when executed by one or more processors (e.g., the processor 1520), may cause the one or more processors to perform a function corresponding to the instruction. The non-transitory computer-readable storage media, for example, may be the memory 1530.

A non-transitory computer-readable recording medium may include a hard disk, a magnetic media such as a floppy disk and a magnetic tape, an optical media such as compact disc ROM (CD-ROM) and a DVD, a magneto-optical media such as a floptical disk, and hardware devices such as a ROM, RAM, and a flash memory. Also, a program instruction may include not only a mechanical code such as things generated by a compiler but also a high-level language code executable on a computer using an interpreter. The above hardware unit may be configured to operate via one or more software modules for performing an operation of the present disclosure, and vice versa.

for example, a storage medium storing instructions according to the above-described embodiment, the instructions, which executed by at least one processor, causing the at least one processor to perform at least one operation, the at least one operation including obtaining contents, deciding one or more extraction items on the contents, extracting a value, corresponding to the extraction item, from the contents, and providing reconstructed information including the extraction result.

A module or a programming module according to an embodiment of the present disclosure may include at least one of the above elements, or a portion of the above elements may be omitted, or additional other elements may be further included. Operations performed by a module, a programming module, or other elements according to an embodiment of the present disclosure may be executed sequentially, in parallel, repeatedly, or in a heuristic method. Also, a portion of operations may be executed in different sequences, omitted, or other operations may be added.

According to various embodiments of the present disclosure, necessary information may be extracted from various formats of contents including a lot of unnecessary information or text and may be provided to a user.

Also, according to various embodiments of the present disclosure, it may be possible to improve readability of contents, a user interface, accessibility, and the like.

Furthermore, according to various embodiments of the present disclosure, a template used to extract information may be consistently updated, thereby improving accuracy and reliability of information extraction.

According to various embodiments of the present disclosure, the availability and convenience of an application associated with provided information may be improved, and additional information may be provided through an associated external link.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for providing information at an electronic device, the method comprising:
obtaining contents;
determining one or more extraction items on the contents;
extracting one or more values, corresponding to the determined one or more extraction items, from the contents; and
providing reconstructed information by including the extraction result.

2. The method of claim 1, wherein the determining of the one or more extraction items comprises:
determining a template to be applied to the contents; and
determining a plurality of extraction items included in the template.

3. The method of claim 2, wherein the determining of the template comprises:
determining metadata associated with the contents; and
selecting at least one template corresponding to the metadata.

4. The method of claim 3, wherein the metadata comprises at least one of information on an application associated with the contents or source information of the contents.

5. The method of claim 3, wherein the metadata comprises a language set at the electronic device, and
wherein the providing of the reconstructed information provides the reconstructed information by the set language.

6. The method of claim 3, wherein the template comprises a pre-condition item, and
wherein the determining of the template further comprises determining a template, in which the pre-condition item is satisfied by the contents, from among the at least one template selected.

7. The method of claim 1, wherein the extracting comprises:
obtaining extraction information of each one of the one or more extraction items; and
extracting a value corresponding to the each of the one or more extraction item based on the obtained extraction information.

8. The method of claim 7, wherein the extraction information comprises at least one of node information indicating a specific position at a structure of the contents or a regular expression indicating a format of a text included in the contents.

9. The method of claim 1, wherein the one or more extraction items comprises at least one essential extraction item, and
further comprising:
transferring, if extraction on at least one item among the at least one essential extraction item fails, a failure log to a server.

10. The method of claim 2, wherein the determining of the template comprises:
transferring, if failing to determine the template, a failure log to a server;
receiving at least one additional template from the server in response to the transferred failure log; and
determining at least one of the at least one additional template as a template for extracting information included in the contents.

11. The method of claim 10, further comprising:
transferring, if no additional template is received from the server, a template update reservation request requesting a template or notification provision when an additional template on the failure log is provided from the server.

12. The method of claim 1, further comprising:
transferring a log on the extraction result to a server periodically.

13. The method of claim 1, wherein the providing of the reconstructed information comprises:
replacing a first screen based on the contents, with a second screen constructed to have a format different from the first screen, and
wherein the second screen is configured to include the reconstructed information.

14. The method of claim 13, wherein the reconstructed information comprises at least one of another application item associated with the reconstructed information or an external link item.

15. The method of claim 1, wherein the providing of the reconstructed information comprises:
outputting the reconstructed information to at least a portion of a first screen, based on the contents, in an overlay manner.

16. The method of claim 1, wherein the providing of the reconstructed information comprises:
outputting the reconstructed information to a notification bar area.

17. An electronic device, comprising:
a control module configured to obtain contents; and
an information extraction module configured to:
determine one or more extraction items on the contents, and
extract one or more values corresponding to the determined one or more extraction items,
wherein the control module is configured to provide reconstructed information including the extraction result.

18. The electronic device of claim 19, further comprising:
a template manager configured to determine a template to be applied to the contents,
wherein the information extraction module is configured to determine a plurality of extraction items included in the template.

19. The electronic device of claim 19, wherein the reconstructed information is set to be provided to a wearable device coupled with the electronic device.

20. A non-transitory storage medium storing instructions, the instructions, which executed by at least one processor, causing the at least one processor to perform at least one operation, the at least one operation comprising:
obtaining contents;
determining one or more extraction items on the contents;
extracting one or more values, corresponding to the determined one or more extraction items, from the contents; and
providing reconstructed information including the extraction result.
